(19) United States
(12) Patent Application Publication
(10) Pub. No.: US 2020/0055876 A1
(43) Pub. Date: Feb. 20, 2020

(54) TRINUCLEAR GOLD(I) CHEMOSENSOR FOR METAL ION DETECTION

(71) Applicant: University of North Texas, Denton, TX (US)

(72) Inventors: Mohammad A. Omary, Denton, TX (US); Sreekar Babu Marpu, Denton, TX (US)

(73) Assignee: University of North Texas, Denton, TX (US)

(21) Appl. No.: 16/546,001

(22) Filed: Aug. 20, 2019

Related U.S. Application Data
(60) Provisional application No. 62/719,777, filed on Aug. 20, 2018.

(51) Int. Cl. C07F 1/00; G01N 21/76; G01N 21/78

(52) U.S. Cl. CPC C07F 1/005; G01N 21/78; G01N 21/76

(57) ABSTRACT

A phosphorescent chemosensor based on A Gold(I) complex stabilized in an aqueous polymer media. The complex exhibits strong red emission (λₘₐₓ ˜690 nm) in solutions and is sensitive to sub-ppm/nM levels of silver ions. On addition of silver salt to the polymer-complex, a bright-green emissive adduct with peak maximum within 475-515 nm is developed. The silver adduct exhibits a four-fold increase in quantum yield (0.19±0.02) compared to polymer-complex alone (0.05±0.01), along with a corresponding increase in phosphorescence lifetime. The polymer-complex also exhibits sensitivity to higher concentrations (e.g., >1 mM) of other metal ions such as Tl⁺, Pb²⁺, and Gd³⁺. The sensing methodology is simple, fast, and convenient, and the results can be detected by the naked eye. Addition of EDTA restores the red emission of the complex. The complex can distinguish between silver ions and silver nanoparticles and can be used to remediate silver ions from the environment.

### RELATED APPLICATIONS

This application claims priority under 35 U.S.C. § 119(e) to U.S. Provisional Patent Application No. 62/719,777 filed Aug. 20, 2018, which is incorporated herein by reference.

### GOVERNMENT SUPPORT

This invention was made with government support under Grant No. CHE-1413641 awarded by the National Science Foundation. The government has certain rights in the invention.

### BACKGROUND OF THE INVENTION

Luminescent sensors for the detection of external stimuli such as heavy metal ions, pH, and CO₂ have been receiving significant attention for many years. Silver ion sensing, in particular, has received immense attention, due to their wide use in the pharmaceutical industry, electronics, food preservation, and other industrial consumer products. Silver ions can also accumulate and cause environmental toxic effects to humans and aquatic animals. Several research groups have investigated fluorescent chemical sensors for the detection of various heavy transition metal ions, such as Hg²⁺, Pb²⁺, Ag⁺, Cu²⁺, and Zn²⁺. Generally, such sensors are based on fluorescence quenching, enhancement, or wavelength change. Compared to organic fluorophores, transition metal-based phosphorescent complexes have a plethora of unique and advantageous photophysical properties such as higher quantum yields, longer lifetimes, larger Stokes' shift, and higher sensitivity and/or selectivity to local environments.

Only a limited amount of literature is available for the detection of silver ions using fluorescence methods in aqueous or biological media. Among them, Chatergee et al. demonstrated silver ion detection using a fluorogenic rhodamine derivative. Arulraj et al. (Sensing and Bio-Sensing Research. 2015, 6, 19) have reported the sensing of silver ions using the organic molecule thionine as a fluorescent probe. Sharma et al., (Eur. J. Inorg. Chem. 2014, 31, 5424) have demonstrated silver sensing using a fluorescent organic nanoparticle system. Lastly, Schmittel et al., (Inorg. Chem. 2007, 46, 9139) has reported an Iridium-based crown ether complex for detection of silver ions in MeCN/H₂O system. Thus, it appears, this is the only demonstration of silver sensing employing a heavy-metal-based chemosensor in aqueous medium. Additionally, the generation of the chemosensor is very straightforward and single step process vs multistep in the literature. Also, the fact that the chemosensor will detect the free silver ions within a nanosilver media. Therefore, given the fact that nanosilver is inducing toxicity concerns for the environment and with limited investigations existing in aqueous solutions, new materials or technologies for detecting silver ions are very significant. Also, it was found that the above-described literature fails to comment on reversibility or recoverability of the sensors. More importantly, all of these systems are fluorescent based with no reports on changes in the lifetime of the sensors relative to differentiating the presence vs absence of silver ions. Additionally, it has been found that one of the largest sources of silver contamination is from engineered silver nanoparticles also referred to as nanosilver. In the last decade, many commercial products including toothpastes, bandages, deodorants, kitchen utensils, beddings, paints, etc. have been loaded with nanosilver for its strong antibacterial properties. This poses a strong toxicity and environmental concerns to both researchers and general public. Understanding the exact mechanism of toxicity of nanosilver is very challenging due to dynamic morphological and chemical changes of nanosilver in contact with biological media or the environment. Ability to sense free silver ions and differentiating them within nanosilver is one important step in the right direction.

Phosphorescent Au(I) complexes including the cyclic trinuclear (aka “trimer” or “cyclotrimer”) complexes represented herein possess rich intramolecular/intermolecular Au . . . Au (aurophilic) interactions. Such aurophilic interactions have been shown to cause striking luminescence properties arising from a variety of (supra)molecular arrangements of Au(I) complexes and have been attributed to correlation and relativistic effects. The rich photophysical properties arising from these effects can be tuned by altering the size and type of the ligand, nature of the media, pH, solvent, and by the addition of metal cations or aromatic molecules.

The problem is there are a limited number of practical solutions for the detection of metals such as silver using chemosensors. Currently a combination of techniques are available to quantify silver ions in solution, however the leaching of silver ions from nanosilver cannot be detected or quantified without sacrificing the sample, a major hindrance for understanding the toxicity role of different silver species in biological systems. Accordingly, there is a need for a highly sensitive chemosensor that can visually indicate the presence of a metal such as silver at very low concentrations in various media and even in presence of nanosilver.

### SUMMARY

Herein is reported a phosphorescent chemosensor based on a trinuclear Au(I) pyrazolate complex or [Au(3-CH₃,5-COOH)Pz]₃, (aka Au₃Pz₃) stabilized in aqueous chitosan (CS) polymer media. Au₃Pz₃ is synthesized in situ within aqueous CS media at pH ˜6.5 and room temperature (RT). Au₃Pz₃ exhibits strong red emission (λₘₐₓ ˜690 nm) in such solutions. The Au₃Pz₃ emission is found to be sensitive to sub-ppm/nM levels of silver ions. On addition of silver salt to Au₃Pz₃/CS aqueous media, a bright-green emissive adduct (Au₃Pz₃/Ag⁺) with peak maximum within 475-515 nm is developed. The silver adduct in solution exhibits a four-fold increase in quantum yield (0.19±0.02) compared to Au₃Pz₃ alone (0.05±0.01), along with a corresponding increase in phosphorescence lifetime. With almost zero interference from 15 other metal ions tested, Au₃Pz₃ exhibits extreme selectivity for Ag⁺ with a 0.02 ppm detection limit. Au₃Pz₃ exhibits sensitivity to higher concentrations (>1 mM) of other metal ions (Tl⁺/Pb²⁺/Gd³⁺). The sensing methodology is simple, fast, convenient, and can even be detected by the naked eye. On addition of ethylenediaminetetraacetic acid (EDTA), the red emission of Au₃Pz₃ is restored. Au₃Pz₃ and its silver adduct retain their characteristic photophysical properties in thin-film forms. Remarkable photostability with <7% photobleaching after 4 hours of UV irradiation is attained for Au₃Pz₃ solutions or thin films.

Accordingly, this disclosure provides a trinuclear Au(I) complex of Formula I:

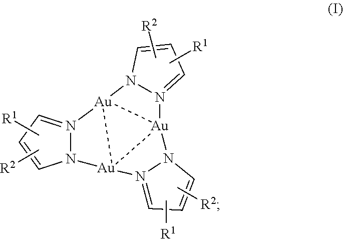

or an ion thereof, wherein:
R¹ is —CO₂H, or branched or unbranched —(C₁-C₆)alkyl-CO₂H; and
R² is H, halo, branched or unbranched —(C₁-C₆)alkyl, or aryl;
   wherein —(C₁-C₆)alkyl and aryl are optionally substituted. The pyrazole heterocycle can also be replaced with other nitrogen heterocycles having a carboxylic acid substituent, for example, a pyridazine or other nitrogen heterocycle comprising two nitrogen atoms in the ring.

This disclosure also provides a chemosensor composition comprising:
a) a cyclic gold (I) trimer;
b) a nitrogen heterocycle having a carboxylic acid substituent; and
c) a polysaccharide in aqueous media at a pH of about the pKa of the polysaccharide;

wherein the gold (I) trimer and the heterocycle form a complex, or an ion thereof, via N—Au—N bonds, and the composition is phosphorescent, exhibits a red emission, and has a Stokes shift of about 150 nm or greater.

Additionally, this disclosure provides a method of chemosensing metal ions comprising:
a) contacting a sample comprising metal ions with the chemosensor composition according to the disclosure above, wherein the chemosensor composition forms phosphorescent adducts with the metal ions; and
b) sensing the emission color of the phosphorescent adducts;

wherein the metal ions are sensed via a difference in the emission color of the chemosensor composition described above and the phosphorescent adducts.

Furthermore, this disclosure provides a method of sensing a presence or absence of silver ions in a sample comprising:
a) contacting a sample with the chemosensor composition according to the disclosure above to form a mixture, wherein the chemosensor composition forms a phosphorescent adduct with a silver ion when the sample comprises silver ions; and
b) sensing the emission color of the mixture;

wherein a presence of silver ions in the sample is sensed via a difference in the emission color of the chemosensor composition and the mixture when the concentration of silver ions in the sample is above about 5 ppb; and

wherein an absence of presence of silver ions in the sample is sensed via no essential difference in the emission color of the chemosensor composition and the mixture when the concentration of silver ions in the sample is below about 5 ppb.

The invention provides a novel complex of Formula I, intermediates for the synthesis of a complex of Formula I, as well as methods of preparing a complex of Formula I. The invention also provides a complex Formula I that are useful as intermediates for the synthesis of other useful complexes.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. PL spectra of Au₃Pz₃ in CS polymer vs polymer-free aqueous media at pH ˜6.5 and RT. The inset shows pictures of red-emissive Au₃Pz₃ synthesized in CS polymer (top photo) and polymer-free media (bottom photo). Quantum yield and lifetime values are labeled. Solid and dashed lines represent Au₃Pz₃ in aqueous CS media and polymer-free DI water, respectively. The solid line indicating a weak emission from a CS/pyrazole control solution is also shown.

FIG. 2. Typical photoluminescence spectra of Au₃Pz₃ (dark lines) and Au₃Pz₃/Ag⁺ (grey lines) in aqueous CS media at pH ˜6.5 and RT. The solid lines represent emission spectra and dashed lines represent excitation spectra. The inset shows quantum yield and lifetime values for complex and adduct.

FIG. 3. Selectivity of Au₃Pz₃ to silver over various other metals in aqueous CS media at pH ˜6.5 and RT. Titration with 4.97 μM concentration of each salt. (A) Emission spectra at 325 nm excitation after addition of each metal ion individually, (B) Folds of enhancement of emission intensity at ˜475 nm. Iₒ and I refer the emission intensity before and after addition of metal ions. (a=Pb²⁺, b=Li⁺, c=Zn²⁺, d=Co²⁺, e=Cd²⁺, f=Fe³⁺, g=Hg²⁺, h=Cu²⁻, i=Ni²⁺, j=Al³⁺, k=Cs⁺, l=K⁺, m=Tl⁺, n=Eu³⁺, o=Gd³⁺). The “*” indicates weak emission from impurities in chitosan. Pictures were taken with a handheld UV lamp.

FIG. 4. Measurement range and detection limits of silver sensor. A) Titration of Au₃Pz₃ in 1.0 w/w % CS with gradual addition of Ag⁺ aliquots (0→11 ppm in 0.52 ppm increments) at pH ˜6.5 (λ_{exc} 325 nm/λₑₘ 475 nm; inset shows the schematic illustration of Auz₃Pz₃ interactions with Ag⁺). B) I/Iₒ for detection limit based on 10% intensity change; the B′ inset zooms out the 0→2.1 ppm region with 0.005 ppm increments.

FIG. 5. Photoluminescence spectra demonstrating reversibility of silver sensing using EDTA. (Black solid—Au₃Pz₃; Grey solid/Grey dashed—Au₃Pz₃/Ag⁺; Black dash/Black dotted (overlapped with black solid)—Au₃Pz₃/Ag⁺/EDTA).

FIG. 6. PL spectra of different heavy-metal ions in aqueous Au₃Pz₃/CS at pH ˜6.5 and RT. Color coding (arrows): Blue=Tl⁺ (85 mM); Dark cyan=Gd³⁺ (0.7 mM); Cyan=Pb²⁺ (100 mM); Green=Ag⁺; Red=Gd³⁺ * (0.7 mM); White=Ag⁺/Tl⁻ (1:1:1 volume admixture with Au₃Pz₃). Inset shows pictures of different adducts under handheld UV lamp (365 nm except Gd³⁺ * used 254 nm). Refer to FIG. 13 and FIG. 14 for excitation spectra.

FIG. 7. Photophysical properties of thin films of Au₃Pz₃ and Au₃Pz₃/Ag⁺ adduct in CS. The dark and grey solid lines represent the emission spectra of Au₃Pz₃ and the silver adduct, respectively. The dashed dark and grey lines represent the excitation spectra of Au₃Pz₃ and Au₃Pz₃/Ag⁺, respectively. The black solid and dashed lines (below about 300 nm) represent the UV/vis absorption spectra of Au₃Pz₃ and the silver adduct, respectively. Insets show emissive films under hand-held UV lamp at 254 nm for Au₃Pz₃ and at 365 nm for Au₃Pz₃/Ag⁺ adduct. Lifetime values and quantum yield numbers are also listed.

FIG. 8. Photostability experiment of Au₃Pz₃ in aqueous solution of chitosan polymer at room temperature. Illumination was performed under 290 nm UV excitation for 4 hours. The overlapping PL data are monitored before (grey-colored spectra) and after illuminating for 4 hr (dark-colored spectra); emission spectra are on the right side while luminescence excitation spectra are on the left side. A total 6.9% photo-degradation in 4 hours is obtained from the results shown in the inset, which represent an upper limit given the experiments did not account for lamp intensity drift.

FIG. 9. The interference effect of Au₃Pz₃ for silver sensitivity. (A) Titration data. (B) I/I₀ data.

FIG. 10. (A) Photoluminescence spectra of Au₃Pz₃ in 1.0 w/v % CS solution (λ_{exc} 305 nm and λₑₘᵢ 475 nm, pH ˜6.5 at room temperature) upon gradual addition of silver ion from 0 to 0.05 ppm for determining the detection limit based on 10% change in emission intensity. (B) Linearity between emission ratio vs silver concentration (from 0 to 2.1 ppm) for the same purpose of determining the detection limit.

FIG. 11. (A) PL spectral titration of Au₃Pz₃ in 1.0% CS upon addition of a 0.52-ppm aliquot of Ag⁻ using λ_{exc}=325 nm at pH 6.5, showing the full (top) and zoomed (bottom) range. (B) PL spectral titration of Au₃Pz₃ in 1.0% CS upon addition of 0.53-ppm and 1.06-ppm consecutive aliquots of Ag⁺ using λ_{exc}=325 nm at pH 6.5, showing the baseline-corrected spectra (top) and data manipulation thereof (bottom) range.

FIG. 12. (A) PL spectral titration of Au₃Pz₃ in 0.1% CS/0-2.2 ppm upon addition of a 0.05341-ppm aliquot of Ag⁺ (λ_{exc}=325 nm; pH 6.5). (B) PL spectral titration of Au₃Pz₃ in 0.1% CS/0-2.2 ppm upon addition of 0.11-ppm and 0.27-ppm consecutive aliquots of Ag⁺ using λ_{exc}=325 nm at pH 6.5, showing the baseline-corrected spectra (top) and data manipulation thereof (bottom) range.

FIG. 13. (A) PL spectral titration of Au₃Pz₃ in 0.1% CS/0-11 ppm upon addition of a 0.53-ppm aliquot of Ag⁺ (λ_{exc}=325 nm; pH 6.5), showing the full (top) and zoomed (bottom) range. (B) PL spectral titration of Au₃Pz₃ in 0.1% CS/0-11 ppm upon addition of 0.53-ppm and 2.10-ppm consecutive aliquots of Ag⁺ using λ_{exc}=325 nm at pH 6.5, showing the baseline-corrected spectra (top) and data manipulation thereof (bottom) range.

FIG. 14. (A) PL spectra of titration of Au₃Pz₃ in aqueous solution of chitosan upon of gradual addition [(0→103 μM; increments of 4.97 μM); 0, 4.97, 9.90, 14.77, 19.60, 24.39, 29.12, 33.81, 38.46, 43.06, 47.61, 52.13, 56.60, 61.03, 65.42, 69.76, 74.07, 78.34, 82.56, 86.75, 90.09, 95.02, 99.09, 103.13 μM)] of Ag⁻ at excitation 285 nm at pH 6.5 (˜470 nm). (B) Plot of emission of integrated total peak area of Au₃Pz₃ as a function of concentration of Ag⁺ ion. I₀ and I is before and after addition of Ag⁺ ion, respectively.

FIG. 15. Job plots: The stoichiometry of Ag⁺/Au₃Pz₃ adduct was determined by continuous variation method or Job plot. The solutions of AgNO₃ and Au₃Pz₃ of equal concentrations were prepared in DI water and in chitosan solution, respectively. Next, solutions of Ag⁺ and Au₃Pz₃ were mixed at different proportions by maintaining a total volume of 3 mL for the mixture. The different ratios of Au₃Pz₃:Ag⁺ (v/v) were 3.000:0, 2.990:0.010, 2.980:0.020, 2.970:0.030, 2.960:0.040, 2.950:0.050, 2.940:0.060, 2.930:0.070, 2.920:0.080, 2.910:0.090, 2.900:0.100, 2.800:0.200, 2.6:0.4, 2.4:0.6, 2.2:0.8, 2:1, 1.8:1.2, 1.6:1.4, 1.5:1.5, 1.4:1.6, 1.2:1.8, 1:2, 0.8:2.2, 0.6:2.4, 0.4:2.6, 0.2:2.8, and 0:3. The emission spectra were recorded immediately after preparing these samples. The emission intensity at 525 nm was used to plot the graph against mole fractions of [Ag⁺]/([Ag⁺]+[Au₃Pz₃]). In the plot, the mole fraction of Ag⁺ at which the summed concentration of ([Ag⁺]+[Au₃Pz₃]) gives maximum emission intensity indicates the stoichiometry of Ag⁺:Au₃Pz₃.

FIG. 16. Excitation for different metal adducts.

FIG. 17. Comparing the emission spectra of different metal adducts vs a control chitosan/pyrazole (CS-Pz) aqueous solution indicated as a dotted line, demonstrating lack of signal interference for each composition from that of any other.

FIG. 18. (A) PL data of red thin-film of Au₃Pz₃ obtained from chitosan-stabilized solution. Insect a picture of red film at room temperature with UV handheld lamp (short wavelength 254 nm). (B) Measurements of absolute quantum yields of red thin-film (of A). The average measured absolute quantum yield is 48.5%.

FIG. 19. A) Spectra of AuT alone, AuT+Ag, AuT+AgNP, and 1 wt % CS. Inset photographs were taken under a hand-held UV lamp under both long and short wavelength (254 nm and 365 nm) associated with the spectra. B) Square dotted line: One addition of AgNP with subsequent additions of Ag⁺ ions. Round dotted line: One addition of silver ions with subsequent additions of AgNPs. The Ag⁺ ions were prepared at the same concentration as the AgNPs. For all PL, spectra λₑₓ=320 nm and λₑₘ=475 nm.

FIG. 20. A) AuT sensing the leaching of silver ions from 20-nM AgNPs over 35 days. The control spectrum of the silver ion titration was done at the same concentration as the AgNP (0.02 mg/mL). B) UV-Vis spectra of 20-nM AgNPs. Spectra were collected the same day the data in A were taken. Inset chart shows the change in FWHM and peak maximum of the AgNP UV-Vis spectra over 35 days. All PL spectra were collected with λₑₓ=320 nm and λₑₘ=475 nm.

FIG. 21. A) AuT sensing of silver ion concentration of 100-nM AgNPs before and after the AgNPs have been dialyzed for 7 days. B) UV-Vis spectra of the 100-nM AgNPs before and after dialysis. Spectra were collected the same day the data in A were taken. For all PL spectra, λₑₓ=320 nm and λₑₘ=475 nm.

FIG. 22. A) AuT silver sensitivity at pH 4 and pH 6 in water. Inset graphic shows the change of the carboxylic acid functional group to carboxylate at pH 4 and pH 6. B) AuT remediation of silver ions in water at pH 6. Silver ions were added to a solution of AuT then excess KCl was added. A fresh solution of AuT was used for every point from the same stock solution. C) AuT remediation of silver ions in water at pH 6. KCl was first added to the AuT then a silver titration was performed. This data set was compared to the control data set (square dotted line)—which was a silver titration with AuT where no KCl was present. For all PL spectra, λₑₓ=320 nm and λₑₘ=475 nm.

FIG. 23. PL spectra of Au₃Pz₃ in different media at RT. The inset shows pictures of red-emissive Au₃Pz₃ synthesized in different media. The Au₃Pz₃ is synthesized and stabilized in PAA (polyacrylic acid media) at two different pH (pH 7.0 and 9.0); CS-Oligo (chitosan oligosaccharide lactate); RPMI (Roswell Park Memorial Institute) 1640 and phosphate buffer media. The emission and excitation spectra are shown in the figure.

### DETAILED DESCRIPTION

Herein is described the investigation of heavy metal sensing that relies on the formation of sandwich Au(I) trimer adducts in aqueous media, resulting in distinguishable luminescent properties. A majority of the Au(I) trimer complexes exhibit intertrimer association in the solid state with very few known examples in solution (mostly organic solvents). In the solid state, intertrimer and intratrimer aurophilic interactions usually manifest themselves by ca. 3.0-3.7 Å crystallographic Au . . . Au distances, which significantly shorten when the molecule is excited to form excited state oligomers (excimers/extended excimers) with bona fide Au . . . Au covalent bonds. Monomeric units of Au(I) trimer complexes can exist in infinitesimally dilute solutions that preclude intertrimer aurophilic interactions. Consequently, in most cases, this renders many Au(I) trimer complexes non-luminescent in dilute solutions. At higher concentrations and in organogels these trimer complexes can exhibit detectable luminescence. In the present case, to help stabilize the Au . . . Au interactions in aqueous media, a natural linear polysaccharide polymer, chitosan (CS), is employed. CS is known specifically for its biocompatible, biodegradable, and nontoxic properties.

Silver nanoparticles (AgNPs) have well-known antibacterial properties that have stimulated their widespread production and usage, which nonetheless concomitantly raises concerns regarding their release into the environment. Understanding the toxicity of AgNPs to biological systems, the environment, and the role that each silver species (Ag⁺ ions vs AgNPs) plays in that toxicity has received significant attention. One of the critical objectives of this research is the development of a reliable method that can sense and differentiate free silver ions from AgNPs and is able to characterize silver ions leaching from the nanosilver. Several analytical methods described in the literature that are available for sensing silver ions are costly, time-consuming, tedious, and more importantly, destroy the AgNP sample. To address these issues, a phosphorescent gold(I)-pyrazolate cyclic trinuclear complex (AuT) known to detect free silver ions was employed to detect and differentiate silver ions from AgNPs within an AgNP sample.

The advantage of the silver sensor is its ratiometric emission capability that undermines any background interference. The sensor exhibits a strong red emission (λₘₐₓ ˜690 nm) that—in the presence of Ag⁺ ions will form a bright-green emissive adduct with a peak maximum near 475 nm. The presence of AgNPs did not inhibit the silver detection and quantification ability of the phosphorescent silver sensor. In order to understand the chemical transformation of nanosilver, the leaching of silver ions from AgNPs over a period of 35 days was monitored and quantified by measuring the I/I₀ changes of the sensor. Furthermore, through adduct formation, the AuT molecular system was able to remediate free silver ions from the solution. The stronger affinity of the AuT complex to “sandwich” free silver ions was demonstrated in the presence of a KCl salt that is well-documented to form AgCl in the presence of silver ions. This is the only ratiometric luminescence-based silver sensor able to successfully differentiate between Ag⁺ ions and AgNPs, sense the silver leakage from AgNPs, and remediate toxic silver ions from solution.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about1%, about 2%, about 3%, about 4%, about 5%, about 6%, about 7%, about 8%, about 9%, about 10%, about 15%, or about 20%.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983).

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

As used herein, the term “substituted” or “substituent” is intended to indicate that one or more (for example., 1-20 in various embodiments, 1-10 in other embodiments, 1, 2, 3, 4, or 5; in some embodiments 1, 2, or 3; and in other embodiments 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Additionally, non-limiting examples of substituents that can be bonded to a substituted carbon (or other) atom include F, Cl, Br, I, OR′, OC(O)N(R′)₂, CN, CF₃, OCF₃, R′, O, S, C(O), S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂NHC(O)R′, N(R′)N(R′)C(O)R′, N(R′)N(R′)C(O)OR′, N(R′)N(R′)CON(R′)₂, N(R′)SO₂R′, N(R′)SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen or a carbon-based moiety, and wherein the carbon-based moiety can itself be further substituted. When a substituent is monovalent, such as, for example, F or Cl, it is bonded to the atom it is substituting by a single bond. When a substituent is more than monovalent, such as O, which is divalent, it can be bonded to the atom it is substituting by more than one bond, i.e., a divalent substituent is bonded by a double bond; for example, a C substituted with O forms a carbonyl group, C═O, wherein the C and the O are double bonded. Alternatively, a divalent substituent such as O, S, C(O), S(O), or S(O)₂ can be connected by two single bonds to two different carbon atoms. For example, O, a divalent substituent, can be bonded to each of two adjacent carbon atoms to provide an epoxide group, or the O can form a bridging ether group between adjacent or non-adjacent carbon atoms, for example bridging the 1,4-carbons of a cyclohexyl group to form a [2.2.1]-oxabicyclo system. Further, any substituent can be bonded to a carbon or other atom by a linker, such as (CH₂)ₙ or (CR′₂)ₙ wherein n is 1, 2, 3, or more, and each R′ is independently selected.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below. The alkyl can also be optionally partially or fully unsaturated. As such, the recitation of an alkyl group can include both alkenyl and alkynyl groups. The alkyl can be a monovalent hydrocarbon radical, as described and exemplified above, or it can be a divalent hydrocarbon radical (i.e., an alkylene).

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. In other embodiments, the aryl group can have 6 to 60 carbons atoms, 6 to 120 carbon atoms, or 6 to 240 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms. Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

The term “complex” or “coordination complex” refers to a central atom or ion, which is metallic and is called the coordination center, and a surrounding array of bound molecules or ions, that are in turn known as ligands or complexing agents. Many metal-containing compounds, especially those of transition metals, for example, silver and gold, are coordination complexes.

The term “coordinate covalent bond”, refers to a 2-center, 2-electron covalent bond in which the two electrons derive from the same atom. The bonding of metal ions to ligands involves this kind of interaction which can be almost as strong as a covalent bond.

### Embodiments of the Invention

This disclosure provides a trinuclear Au(I) complex of Formula I:

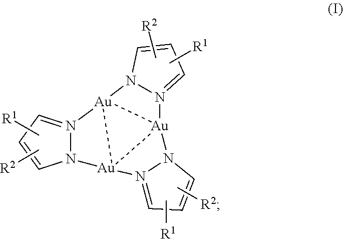

or an ion thereof, wherein:
R¹ is —CO₂H, or branched or unbranched —(C₁-C₆)alkyl-CO₂H; and
R² is H, halo, branched or unbranched —(C₁-C₆)alkyl, or aryl;
   wherein —(C₁-C₆)alkyl and aryl are optionally substituted.

In some embodiments of the disclosed complex, R¹ is —CO₂H and R² is branched or unbranched —(C₁-C₆)alkyl. In other embodiments, R² is —CF₃ or —CF₂CF₃.

This disclosure provides various embodiments of a chemosensor composition comprising:
a) a cyclic gold(I) trimer;
b) a nitrogen heterocycle having a carboxylic acid substituent;
c) a polysaccharide in aqueous media at a pH of about the pKa of the polysaccharide;
d) an optional acrylic acid-based polymer media at different pH; and
e) an optional phosphate buffer media.

wherein the gold(I) trimer and the heterocycle form a complex via N—Au—N coordinate covalent bonds, and the composition is phosphorescent, exhibits a red emission at about the pKa of the polysaccharide, and has a Stokes shift of at least about 150 nm.

In some embodiments, the heterocycle is a pyrazole or a pyridazine, or a heterocycle compatible with the formation of a cyclic gold(I) trimer. In other embodiments, the polysaccharide is a glycosaminoglycan or chitosan. In yet other embodiments, the amount of the polysaccharide in aqueous media is about 0.05% wt/v to about 5% wt/v, or about 0.1% wt/v to about 2% wt/v. In further embodiments, the molecular weight of the polysaccharide, glycosaminoglycan or chitosan is about 1 kDa to about 1000 kDa, about 50 kDa to about 800 kDa, about 100 kDa to about 600 kDa, about 200 kDa to about 500 kDa, or about 150 kDa to about 400 kDa.

In other embodiments, the chemosensor composition comprises step d) an acrylic acid-based polymer media at different pH. In yet other embodiments, the chemosensor composition comprises step e) a phosphate buffer media.

In further embodiments, the red emission is at a wavelength of about 650 nm to about 750 nm, or about 700 nm. In additional embodiments, the pH is about 3.0 to about 8.0, about 6.0 to about 7.5, or about at pH 7. In yet some other embodiments, the Stokes shift is about 200 nm to about 500 nm. In other embodiments, the Stokes shift is about 50 nm to about 100 nm, about 100 nm to about 150 nm, about 150 nm to about 200 nm, about 200 nm to about 250 nm, about 250 nm to about 300 nm, about 300 nm to about 350 nm, about 350 nm to about 400 nm, about 400 nm to about 450 nm, or about 450 nm to about 500 nm.

In various other embodiments, the chemosensor has a phosphorescence quantum yield of about 5% or greater and a phosphorescence lifetime of about 3 microseconds or greater. In other embodiments, the chemosensor has a phosphorescence quantum yield of about 1%, about 2%, about 3%, about 4%, about 5%, about 6%, about 7%, about 8%, about 9%, about 10%, or about 10% to about 20%. In further embodiments, the quantum efficiency (Φ) is about 0.01 to about 0.8, about 0.05 to about 0.8, about 0.1 to about 0.5, or about 0.15 to about 0.3.

In some other embodiments, the chemosensor has a phosphorescence lifetime of about 1 microsecond, about 2 microseconds, about 3 microseconds, about 4 microseconds, about 5 microseconds, about 6 microseconds, about 7 microseconds, about 8 microseconds, about 9 microseconds, or about 10 microseconds to about 25 microseconds.

In various embodiments of the above disclosed composition, the complex comprises Formula I:

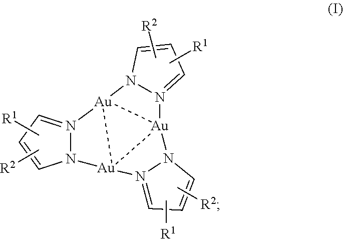

or an ion thereof, wherein:
R¹ is —CO₂H, or branched or unbranched —(C₁-C₆)alkyl-CO₂H; and
R² is H, halo, branched or unbranched —(C₁-C₆)alkyl, or aryl;
   wherein —(C₁-C₆)alkyl and aryl are optionally substituted. In some embodiments, R² is —CF₃ or —CF₂CF₃.

In various embodiments of the above disclosed complex or chemosensor, each R¹ is independently —CO₂H, or independently branched or unbranched —(C₁-C₆)alkyl-CO₂H; and

each R² is independently H, halo, branched or unbranched —(C₁-C₆)alkyl, or aryl;

In other embodiments, the complex comprising Formula I is a complex comprising X:

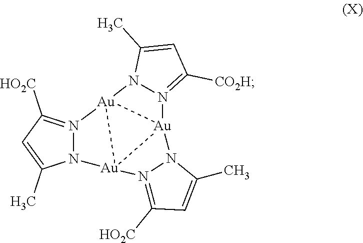

or an ion thereof.

In various embodiments, the complex is stabilized by the polysaccharide. In additional embodiments, the polysaccharide comprises amine substituents, and the complex is stabilized via ion pairing of a carboxylic acid group R¹ of Formula I and an amino group of the polysaccharide. In further embodiments, the stabilized complex has a surface charge that is reduced by about 5 mV to about 20 mV relative to a non-stabilized complex of Formula I. In yet some other embodiments, the composition is photostable wherein about 4 hours of UV irradiation of the composition results in less than 10% photobleaching, less than 20% photobleaching, or less than 5% photobleaching.

Furthermore, this disclosure provides a composition comprising the trinuclear Au(I) complex according to the disclosure above and a metal ion wherein the metal ion is sandwiched by two complexes to form a sandwich complex. This disclosure also provides a thin film comprising the chemosensor according to the disclosed complex or composition, and a substrate.

Also, the disclosure provides a method of chemosensing metal ions comprising:

a) contacting a sample comprising metal ions with the chemosensor composition according to the disclosure herein, wherein the chemosensor composition forms phosphorescent adducts with the metal ions; and

b) sensing the emission color of the phosphorescent adducts;

wherein the metal ions are sensed via a difference in the emission color of the chemosensor composition disclosed herein and the phosphorescent adducts.

In various embodiments, the emission peak of the phosphorescent adducts is blue shifted. In various other embodiments, the metal ions are silver, thallium, lead, or gadolinium. In additional embodiments, the metal ions are silver ions and the limit of detection of the silver ions being sensed is about 1 ppb, 5 ppb, about 10 ppb, about 15 ppb, or about 20 ppb to about 100 ppb. In yet some other embodiments, the emission intensity of the phosphorescent adducts is at least about 5 times greater, or about 5 times to about 25 times greater than the emission intensity of the chemosensor composition disclosed herein. In further embodiments, addition of a metal chelating agent (such as but not limited to EDTA) to the phosphorescent adducts restores the red emission of the chemosensor composition disclosed herein.

Additionally, this disclosure provides a method of sensing (or detecting) a presence or absence of metal ions (e.g. Ag, Pb, Tl, Gd ions, or mixture of ions thereof) in a sample comprising:

a) contacting a sample with the chemosensor composition according to the disclosure herein to form a mixture, wherein the chemosensor composition forms a phosphorescent adduct with a metal (e.g., silver) ion when the sample comprises metal (e.g., silver) ions; and

b) sensing the emission color of the mixture;

wherein a presence of metal (e.g., silver) ions in the sample is sensed via a difference in the emission color of the chemosensor composition and the mixture when the concentration of metal (e.g., silver) ions in the sample is above about 5 ppb; and

wherein an absence of metal (e.g., silver) ions in the sample is sensed via no essential difference in the emission color of the chemosensor composition and the mixture when the concentration of metal (e.g., silver) ions in the sample is about 0.1 ppm to about 20 ppm (or below about 5 ppb for silver ions).

In various other embodiments, a green emissive adduct indicates a concentration of silver ions of at least 5 ppb. In other embodiments, the sample comprises silver nanoparticles. In some other embodiments, the chemosensor composition is insensitive to zero-valent silver (Ag⁰). In further embodiments, sensing the emission color of the mixture is unchanged or substantially unchanged when the presence of salts (for example, potassium chloride) is in the sample.

In additional embodiments, the above method can differentiate the (or is sensitive to) differences in the concentration of a metal ion (e.g., silver ions) wherein the difference in metal ion concentration is less than about 500 ppb, less than about 250 ppb, less than about 100 ppb, less than about 50 ppb, or less than about 25 ppb. In other embodiments, the above method, for example, can differentiate between a silver ion concentration of about 5 ppb in one sample and a silver ion concentration of about 100 ppb in another sample. In some embodiments the emission color can be detected visually, or spectroscopically. In other embodiments, the change in emission color can be detected visually or spectroscopically.

In some embodiments, the sample comprises biological media. In some embodiments, the sample comprises phosphate buffer, RPMI media, or a combination thereof. In yet other embodiments, the sample comprises silver ions and silver nanoparticles. In other embodiments, the method can accurately sense the concentration of silver ions in a sample comprising silver nanoparticles without interference from the silver nanoparticles. In other embodiments the method differentiates free silver ions (Ag⁻) from nanosilver (Ag (0) particles. In other embodiments, the sample is stabilized in biological media. In some other embodiments, different concentrations of silver ions can be differentiated by emission intensity.

In other embodiments, the sample is water wherein KCl is in the water, and KCl in the water does not change or substantially does not change sensing of silver ions in the mixture when the concentration of silver ions in the sample is less than about 25 ppm, about 10 ppm, about 7 ppm, about 5 ppm, or about 3 ppm.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

### Results and Discussion

Herein is reported the formation and chemosensory properties of a phosphorescent complex, {[(3-CH₃,5-COOH)Pz]Au}₃ (aka Au₃Pz₃) stabilized in a CS polymer matrix. This is believed to be the first report in which a cyclic Au(I) trimer complex showed in situ formation within an aqueous polymeric medium while retaining phosphorescence features and also the first ever gold complex capable of sensing sub-ppm levels of silver ions in aqueous solution.

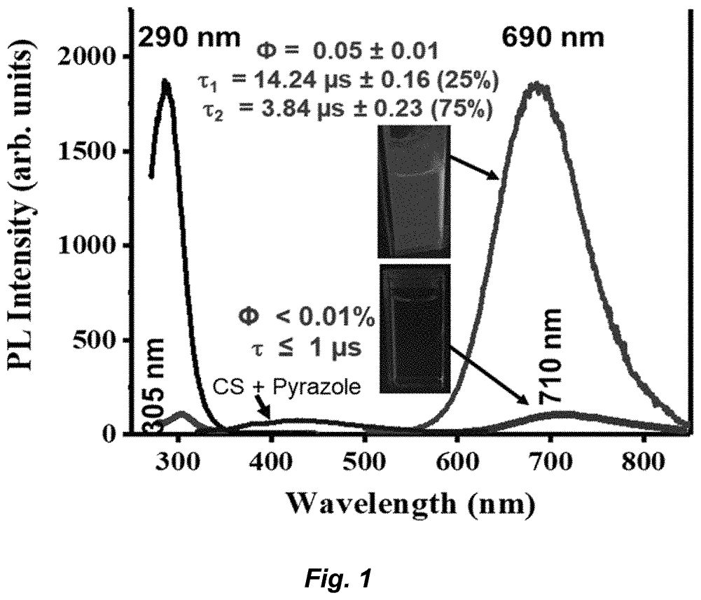

Evidence of formation of Au₃Pz₃. In addition to photoluminescence data presented in the next section, the formation of Au₃Pz₃ in solution was confirmed by ¹H-NMR, ESI-MS, and FT-IR techniques. The photophysical measurements were performed for both CS-stabilized and polymer-free samples of Au₃Pz₃ in DI water (FIG. 1).

The ¹H-NMR spectrum of the PzH ligand shows a singlet broad peak at 12.86 ppm, due to N—H proton resonances at the 1-position of the pyrazole ring. The ionization of the carboxylic acid group (—COOH) renders no distinguishable peak of that proton. Singlets at 6.440 ppm and 2.224 ppm can be attributed to the C4-H and C3-CH₃ protons on this substituted pyrazole. The ¹H-NMR spectrum for Au₃Pz₃ (1) shows the disappearance of the singlet broad peak at 12.86 ppm. This is consistent with the formation of a coordinate-covalent bond between the ligand and gold(I) via its nitrogen atoms (N—Au—N). All other peaks from the ligand remained essentially intact with only minor shifts in their resonances.

ESI-MS data showed distinguishable peaks for the ligand and Au₃Pz₃. The calculated molecular weight for this ligand is 126.0 g/mol, giving rise to m/z=125 in the negative mode of ESI-MS. This fragmentation value indicates ligand deprotonation in aqueous solution, [L−1H]⁻=Pz⁻. The calculated molecular weight of Au₃Pz₃ is 966.0 g/mol and since it has three carboxylate groups substituted on three pyrazolate moieties, fragmentation can be potentially around m/z=322 if all carboxylate protons are lost. However, the spectrum shows no distinct peaks at m/z=322 but a clear peak at m/z=965, [1−H]⁻, indicates the formation of a full trimeric unit of Au₃Pz₃. This ESI-MS pattern suggests an ionization at one of the carboxylic groups present in this complex as COO⁻, whereas the two other units remain protonated (COOH), [Au₃Pz₃-H]⁻.

The FT-IR spectrum of the ligand shows clear peaks at 3243 cm⁻¹, 3151 cm⁻¹, 1715 cm⁻¹ and 1590 cm⁻¹, which are characteristic stretching bands for v(N—H), v(O—H), v(C═O) and v(N—N). Comparatively, Au₃Pz₃ shows FT-IR spectral bands at 3242 cm⁻¹, 3139 cm⁻¹, 1688 cm⁻¹, and 1529 cm⁻¹ for the v_{N—H}, v_{O—H}, v_{C═O}, and v_{N—N} stretching modes. As the reaction is not efficient in polymer-free DI water, there are some residues of unreacted ligand that showed a stretching band at 3242 cm⁻¹ coming from the N—H of uncomplexed PzH. The far-IR region of the gold precursor, Au(THT)Cl, shows a stretching band at 326 cm⁻¹ for v_{Au—S}, which disappears upon Au₃Pz₃ formation concomitant with the appearance of new bands at ˜260 and 150-180 cm⁻¹, which is attributed to v_{Au—N} and δ_{N—Au—N} based upon: a) comparison with multiple experimental and/or computational literature precedents; and b) experimental DFT calculations, relating to predicted IR spectra for an unsubstituted Au₃Pz₃ model to the experimental IR data and to the literature precedents.

Photophysical studies of Au₃Pz₃. Photophysical properties were analyzed by comparing Au₃Pz₃ in polymer vs DI water (polymer-free solution) to understand the effect of the polymer on the formation and stability of Au₃Pz₃. FIG. 1 shows the differences in photophysical properties of Au₃Pz₃ synthesized in the presence vs absence of CS polymer in DI water. The appearance of the red emission band from both systems is an indication of the formation of cyclic Au trimer units and self-assembly of attractive intertrimer units by aurophilic interactions involving adjacent units of Au₃Pz₃, as known for linear Au(I) complexes in general and such cyclotrimers in particular in both the solid state and (albeit organic) solution.

Chart 1 shows the possible intertrimer aurophilic interaction motifs of Au₃Pz₃ units that induce the luminescence in both systems. The presence of the CS polymer not only significantly enhances the formation of Au₃Pz₃ but also promotes aggregation, which is speculated to be at least in part due to ion-pairing the —COO⁻ anionic groups by the polymer —NH₃⁺ groups to ameliorate electrostatic repulsion between otherwise anionic trimer units. The emission and excitation peak maxima for polymer-free aqueous Au₃Pz₃ (λ_{exc}=305 nm and λₑₘ=710 nm) is distinctly different from Au₃Pz₃ (λ_{exc}=290 nm and λₑₘ=690 nm) stabilized in CS polymer. Polymer-free Au₃Pz₃ exhibits rather feeble red emission compared to the bright red emission of Au₃Pz₃ synthesized in CS polymer media (FIG. 1).

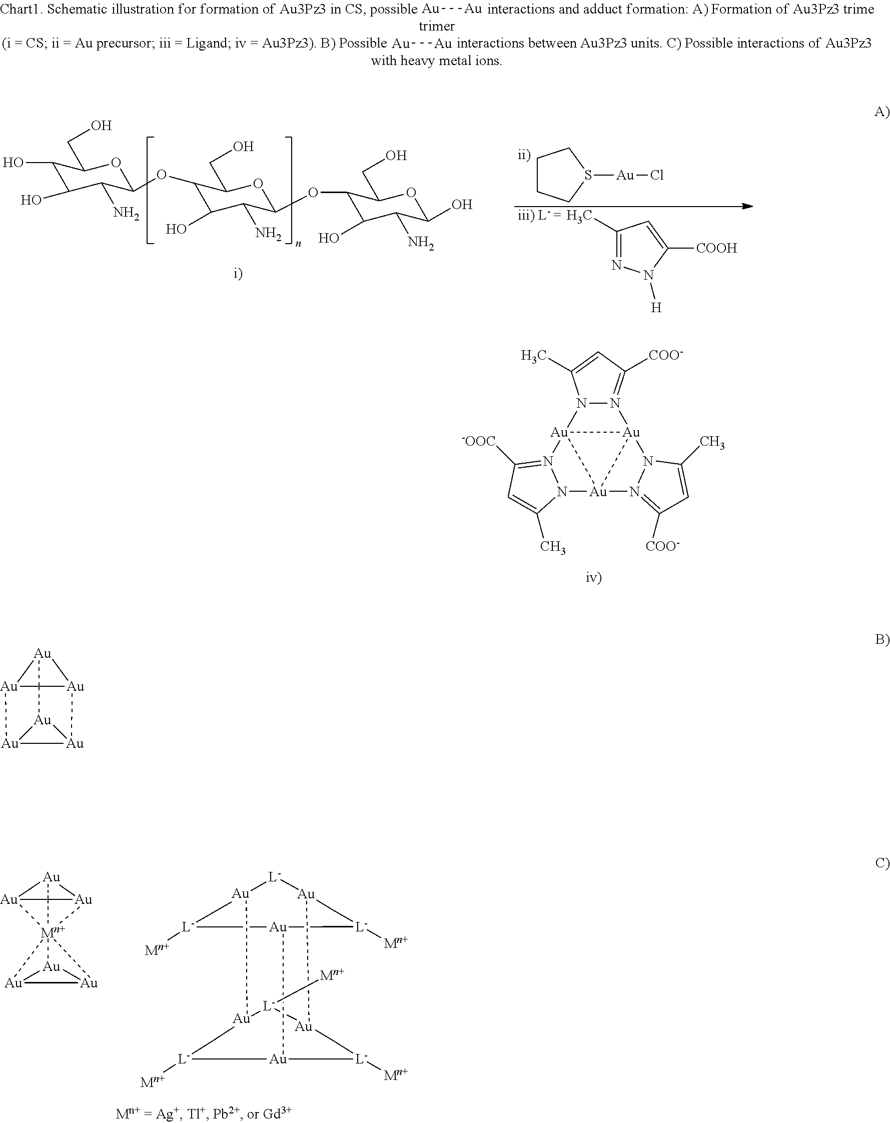

The phosphorescence quantum yield and lifetime of Au₃Pz₃ synthesized in polymer media were much higher compared to Au₃Pz₃ synthesized in polymer-free aqueous media (Table 1). In addition, in the CS matrix, Au₃Pz₃ showed dual-exponential lifetimes. While in polymer-free media, Au₃Pz₃ exhibited rather weak emission with an immeasurable absolute quantum yield and a single exponential lifetime of ˜1 μs, which was close to the time resolution of the flash lamp used in the experiment. It is strongly believed that these differences in photophysical properties of Au₃Pz₃ in polymer vs polymer-free media could be due to a combination of factors: (a) Presence of CS polymer results in better stabilization and high-yield synthesis of Au₃Pz₃. (b) The positively charged CS polymer causes ion-pairing interactions with the tri-anionic monomer Au₃Pz₃ or, hexa-anionic dimer-of-trimer [Au₃Pz₃]₂ units, which stabilizes the complex, resulting in less excited state distortion (emission peak maxima at 690 nm vs 710 nm, respectively). (c) The reduction of the surface charge from +62.7±4.2 mV for free CS to +50.1±3.3 mV for the CS-stabilized Au₃Pz₃ sample represents direct evidence of the aforementioned ion-pairing interactions. (d) Lastly, the presence of the CS polymer significantly reduces the access of water and oxygen quenching molecules to the Au₃Pz₃ chromophore, resulting in both enhanced luminescence and increased stability.

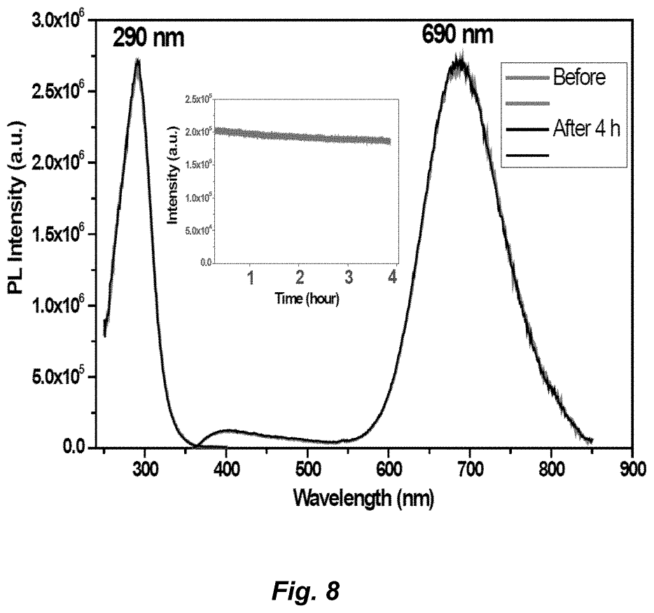

The stability effect of the polymer on the microenvironment is evident from the dual-lifetime behavior of Au₃Pz₃ (FIG. 1). In fact, Au₃Pz₃ samples synthesized in the polymer are stable up to a few months without compromising their photophysical properties, whereas polymer-free aqueous-Au₃Pz₃ decomposes in a few hours. Au₃Pz₃ in CS also exhibits excellent stability against degradation from photobleaching in solution (FIG. 8), with less than 7% change in emission signal after 4 hours of irradiation, suggesting a significant role of the polymer in photostability. This type of behavior is not unusual and there are on enhanced stability and brightness of fluorescent or phosphorescent molecular systems when incorporated into polymers and polymer nanoparticle matrices.

TABLE 1
Summary of Photophysical Properties of Au₃Pz₃.

| Sample | Form | τ (μs) | Φ_{PL} |
|---|---|---|---|
| Au₃Pz₃/H₂O | Soln. | <1 μs | N/A |
| Au₃Pz₃/CS | Soln. | 14.24 ± 0.16 (25%) | 0.05 ± 0.01 |
| | | 3.84 ± 0.23 (75%) | |
| Au₃Pz₃/CS | Film | 14.19 | 0.48 ± 0.05 |
| Au₃Pz₃/CS/Ag⁺ | Soln. | 13.92 ± 0.08 | 0.198 ± 0.02 |
| Au₃Pz₃/CS/Ag⁺ | Film | 10.81 | 0.11 ± 0.03 |

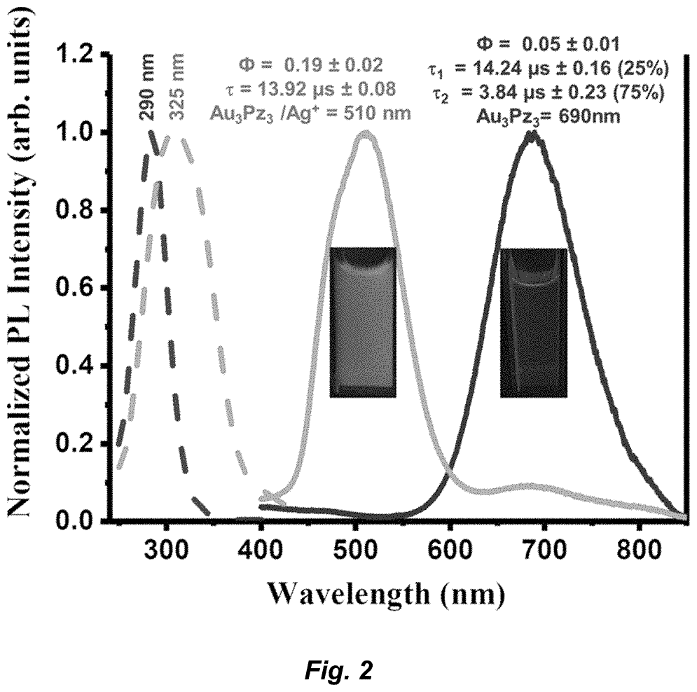

Selective sensing of silver with Au₃Pz₃. Silver ion sensing with Au₃Pz₃ was carried out by titration experiments at RT. Typical steady-state emission and excitation spectra of the Au₃Pz₃/Ag⁺ adduct in polymer media at pH ˜6.5 are shown in FIG. 2. The excitation peak for the Au₃Pz₃/Ag⁺ adduct solution is at λₘₐₓ=305-325 nm while the emission peak is at λₘₐₓ=470-510 nm with the variation depending on the concentration of silver ions. Upon addition of silver into Au₃Pz₃, a new distinct blue-shifted emission peak appears at λₘₐₓ=515 nm with an albeit red-shifted excitation of λₘₐₓ=325 nm, representing a drastic reduction in Stokes' shift by ˜8,830 cm⁻¹ (from 19,990 cm⁻¹ to 11,160 cm⁻¹) vs Au₃Pz₃ alone. The red emission peak at ˜685 nm of Au₃Pz₃ diminishes slowly and essentially disappears after adding 250 μM of silver ions.

The photophysical properties observed for the Au₃Pz₃/Ag⁺ adduct are, therefore, drastically different from those for Au₃Pz₃ alone. The extremely bright green-emissive solution of Au₃Pz₃/Ag⁺ shows a single exponential lifetime τ=13.92±0.08 μs and a quantum efficiency Φ=0.19±0.02 at RT without deaeration. The red shift in the excitation maxima and blue shift in the emission maxima upon addition of silver ions are similar to the changes observed by Burini et al. (Inorg. Chem. 2003, 24, 253) and Aida et al. (J. Am. Chem. Soc. 2005, 127, 179) in solid-state and organogel media. Upon silver sandwiching by Au₃Pz₃ trinuclear complexes, the [Au(I)]₃ . . . Ag(I) . . . [Au(I)]₃ interaction becomes remarkably strong in the ground state, more so than the Au(I) . . . Au(I) intertrimer interaction, which causes the red-shift in excitation.

Likewise, photoexcitation to the phosphorescent state of the Au₃Pz₃/Ag⁺ sandwich adduct will undergo a smaller Stokes' shift than that for the transformation of intertrimer Au(I) . . . Au(I) interactions to excimeric ³[Au(I)—Au(I)]* covalent bonds, because of the strong ground-state metal-metal bonding for Au(I) . . . Ag(I). Aida et al. have shown that the emission color tunability can be achieved by the addition of silver ions to gold(I) pyrazolate trimer complexes composed of long alkyl chains in organic media, due to the formation of organogels. In the solid state, emission color tunability due to intercalation (sandwich type structure) of heavy metal ions between trimer units has been demonstrated. Likewise, the formation of a similar half- or full-sandwich structure between one or two units of Au₃Pz₃, respectively, and the heavy metal ion, (Ag⁺ in particular and, to a lower extent, Tl⁺, Pb²⁻, or Gd³⁺) that results in emission tunability and sensing behavior from the trinuclear gold(I) pyrazolate complex, is proposed. It is also assumed that along with the formation of a sandwich structure, ionic interactions between heavy metal cations and the carboxylated functional groups presented in Au₃Pz₃ can further assist the formation of an emission tunable adduct; see Chart 1 (C).

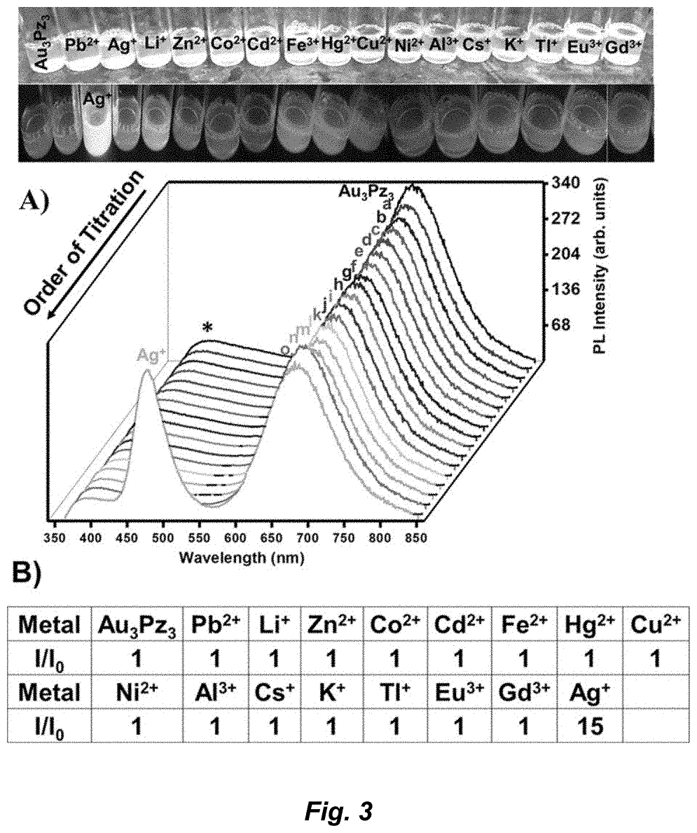

In order to understand the selective sensitivity to Ag⁺, Au₃Pz₃ was separately titrated with 15 different metal ions, each at a constant salt concentration of 4.97 μM. Upon individual titration of metal ions besides Ag⁺, the PL spectrum remained unchanged. Only after addition of silver salt did a new PL band at 475 nm evolve (FIG. 3A). FIG. 3A shows that upon individual titration of 15 other metal ions, the Au₃Pz₃ emission baseline at 475 nm was unaltered. There is a 15-fold emission enhancement from the baseline at 475 nm only in the presence of Ag⁺ (FIG. 3B). The I/I₀ values in FIG. 3B confirm that Au₃Pz₃ is extremely and selectively sensitive to Ag⁺ at ˜5 μM levels. At such low Ag⁺ concentrations, however, the new bright-green emission peak at 475 nm is concomitant with the red PL at 690 nm, indicating the presence of both sandwiched and non-sandwiched units of Au cyclotrimer.

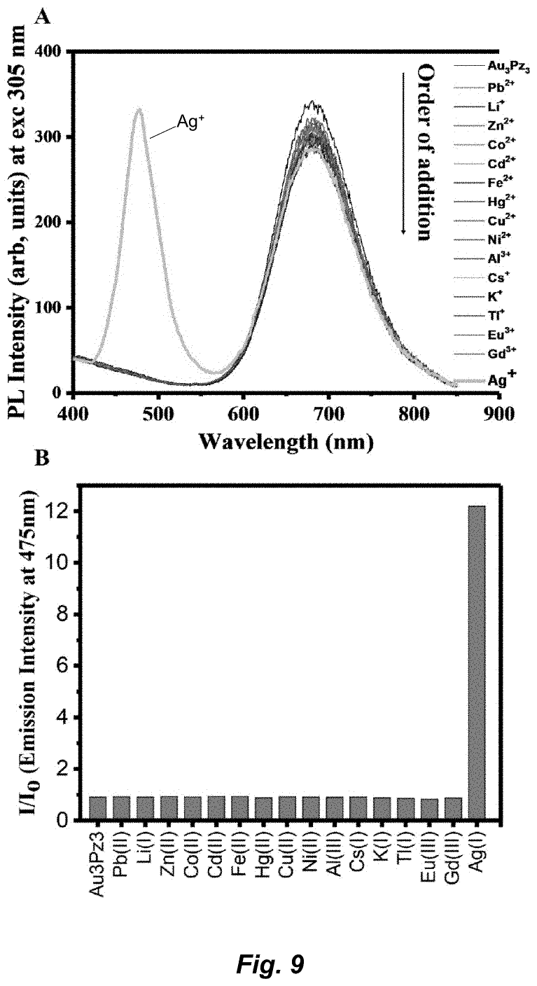

After understanding the selectivity of Au₃Pz₃ for silver ions, the interference effect of other metal ions on the sensitivity of silver was also investigated. At a fixed concentration (4.97 μM), all other metal cations were first added sequentially to the same solution of Au₃Pz₃. The order of addition is indicated in FIG. 9 and the emission spectrum was recorded after addition of each metal ion. It can be clearly noticed that even by this titration process, only after the addition of silver salt the evolution of a new emission peak at 475 nm (FIG. 9A) was observed. Further, I/Iₒ values for silver addition did not appreciably change even in the presence of all the different metal ions in solution. This result shows that the selective detection of Ag⁺ by the Au₃Pz₃ phosphorescent chemosensor for Ag⁺ is immune to interference from other metals salts at ˜5 μM concentrations.

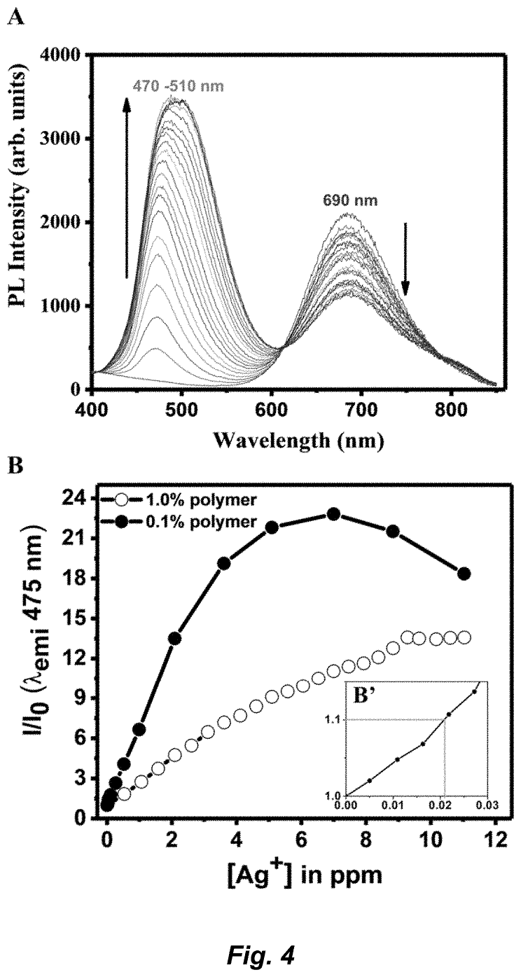

Detection Limit for Silver Sensing by Au₃Pz₃. After understanding the selectivity of Ag⁺ sensing by Au₃Pz₃, the detection limit and a measurement range of Au₃Pz₃ for silver were determined from titration experiments. FIG. 4A shows PL titration data for Au₃Pz₃ by gradual addition of silver salt (0→11 ppm) at pH ˜6.5 and RT. These data demonstrate a stepwise sensitization of the 475 nm PL peak, whereas the 690 nm peak exhibits gradual quenching. The detection limit and measurement range were determined at two polymer concentrations, 0.1 and 1.0 w/v % CS.

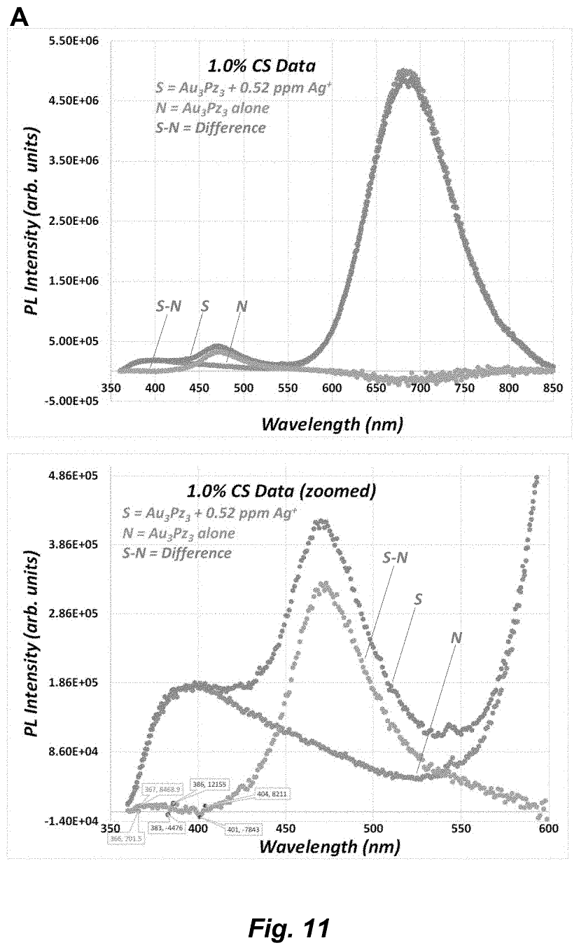

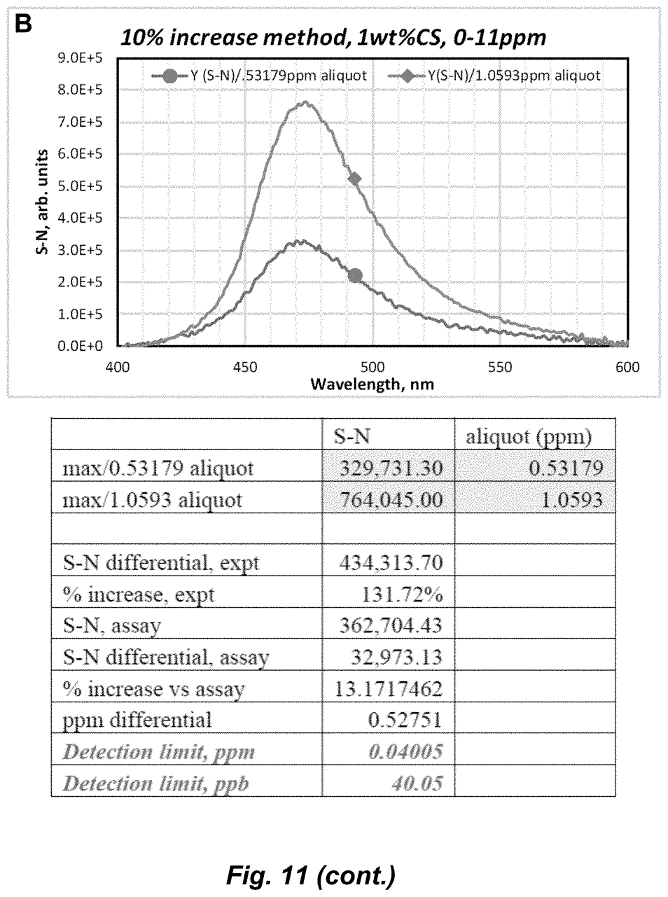

The detection limit was calculated using two methods, S/N>3 (signal-to-noise ratio) and a threshold of 10% increase in PL intensity vs the sensor's signal, and the analysis is done without (Table 2 and FIG. 4) and with (Table 3 and FIGS. 11-13) baseline correction by subtracting the latter signal. The detection limit based on S/N>3, without baseline correction, varied between 1.5 and 0.5 ppm depending on w/v % of CS (Table 2), whereas these values improved by 3 orders of magnitude to ppb/nM levels upon careful manipulations of baseline correction, attaining 6-37 ppb detection limits (Table 3 and FIGS. 11-13).

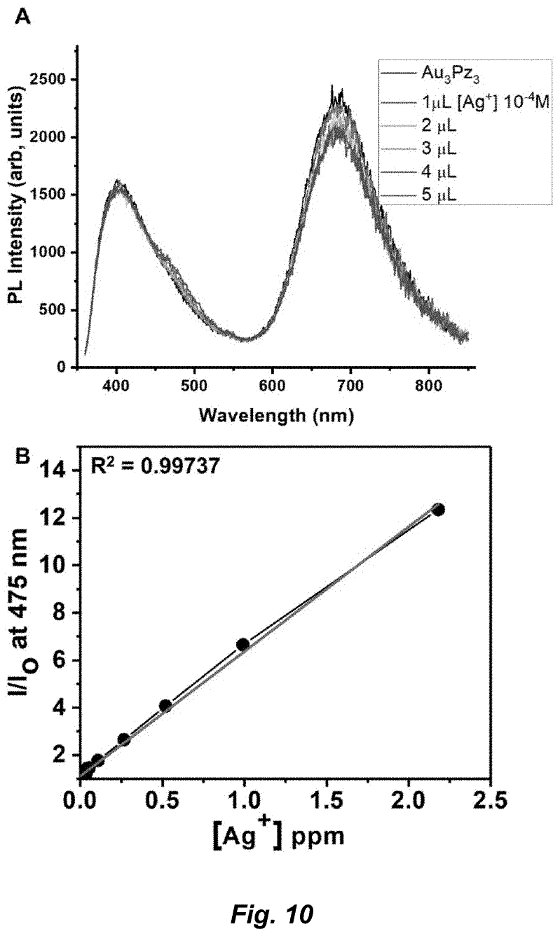

Au₃Pz₃ synthesized at a lower concentration of CS sensed as low as 5 ppb added aliquots (FIG. 10 and Table 2). Au₃Pz₃ synthesized at 1.0% and 0.1% CS exhibits a detection limit (based on 10% signal change) of 0.5 ppm and 20 ppb, respectively, without baseline correction (Table 2 and FIG. 4B), which improved to 40 ppb and 14 ppb, respectively, upon appropriate baseline correction (Table 3 and FIGS. 11-13). Thus, FIG. 4B data suggest that the concentration of CS has a clear effect not only on the detection limit but also on the measurement range of Au₃Pz₃, which varied within <0.5-9.3 ppm at the higher 1.0 w/v % CS while the lower 0.1 w/v % CS reduced the upper limit to 7.0 ppm and lower limit to 5 ppb.

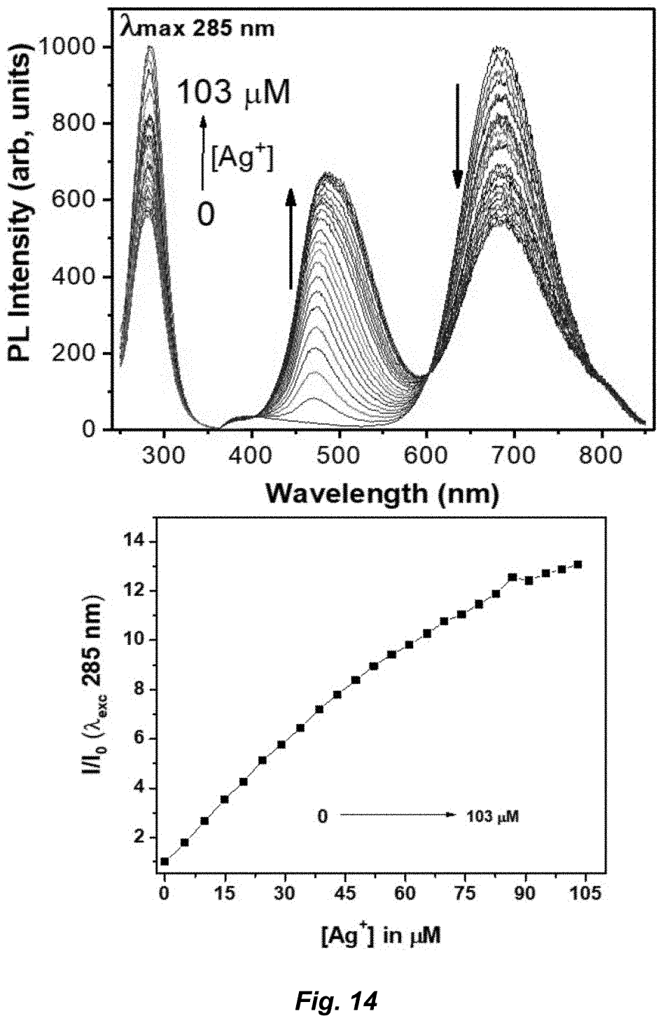

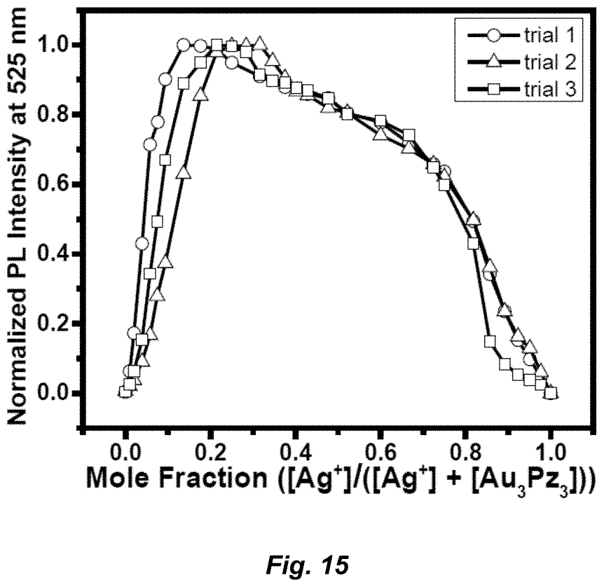

Tabular forms detailing all of the sensitivity parameters for various titrations are listed in Table 2 and Table 3. The addition of silver ions beyond the measurement range of the sensor resulted in a peak shift from 470 to 510 nm. It is hypothesized that this continuous red-shift in emission noticed in FIG. 4A with respect to incremental addition of silver ions is likely due to a change from a half-sandwich to a full-sandwich adduct between Ag⁺ and one or two units of Au₃Pz₃, respectively, with the gradual red-shifting for each adduct resulting from conformational changes that increase the extent of Ag(I)—Au—(I) overlap. A similar rise of a new PL peak at 475 nm using 285 nm excitation (FIG. 14) was also noticed. The interaction of Ag⁺ with Au₃Pz₃ is confirmed from a Job plot (FIG. 15).

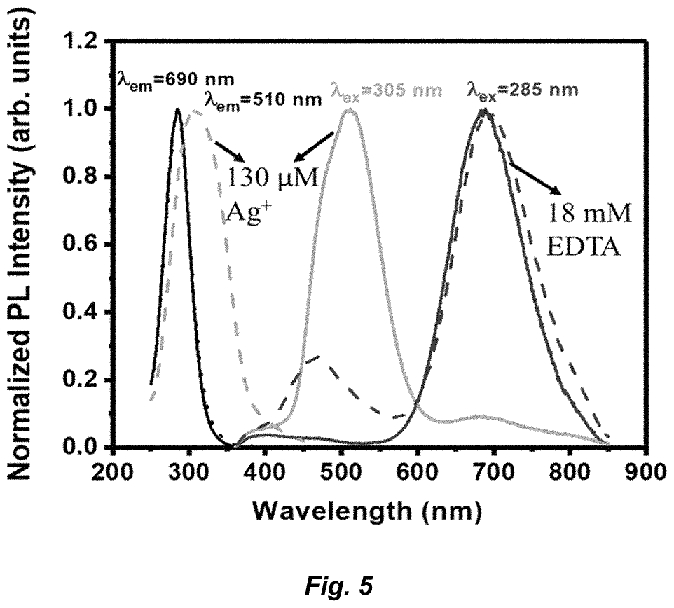

The profile of the Job plot titration suggests an equilibrium between a 1:2 and 1:1 interactions of silver ions with Au₃Pz₃, corresponding to full- and half-sandwich adduct formation, respectively, with a slight preference for the former (˜1.2 peak ratio), as shown in FIG. 15, substantiating the aforementioned hypothesis. Lastly, the reversibility of Ag⁺ sensing was investigated by using the well-known chelating agent, EDTA=ethylenediaminetetraacetic acid, as shown in FIG. 5. The process was repeated for 3 cycles using various Ag⁺ and EDTA concentrations, which tuned the reversibility. A detailed study to assess the reversibility across the entire measurement range of the sensor is under investigation. However, these preliminary results have indicated that Au₃Pz₃ can be used as both a reusable sensor and as a scavenger of silver ions depending on the concentration of both Ag⁺ and EDTA, which may be helpful for addressing toxicity concerns of Ag⁺.

TABLE 2
Detail of the sensitivity numbers for various CS concentrations.

| | | | | Detection | Detection |
|---|---|---|---|---|---|
| Detection | | Range Studied | Incremental | Range | Limit |
| Type | Sample | (ppm) | (ppm) | (ppm) | (ppm) |
| S/N > 3 | High w % | 0 to 11 | 0.52 | 0 to 9.3 | Less than 1.58 |
| 10% Signal | CS | | | | Less than 0.5 |
| Change | | | | | ppm |
| S/N > 3 | Low w % | 0 to 2.2 | 0.005 | | Less than 0.5 |
| 10% Signal | CS | | | | Less than 0.02 |
| Change | | | | | ppm |
| S/N > 3 | Low w % | 0 to 11 | 1.5 | 0 to 7 | Less than 0.5 |
| | CS | | | | ppm |
| 10% Signal | | | | | NA |
| Change | | | | | |

| High w % Polymer | | Low w % Polymer | | Low w % Polymer | |
|---|---|---|---|---|---|
| PPM (Ag⁺) | I/I₀ | PPM (Ag⁺) | I/I₀ | PPM (Ag⁺) | I/I₀ |
| 0 | 1 | 0 | 1 | 0 | 1 |
| 0.53179 | 1.83428 | 0.00545 | 1.02017 | 0.53 | 4.94034 |
| 1.0593 | 2.74389 | 0.0109 | 1.04789 | 2.09 | 1.35E+01 |
| 1.58039 | 3.72524 | 0.01635 | 1.06825 | 3.61 | 1.91E+01 |
| 2.0972 | 4.73677 | 0.0218 | 1.10698 | 5.09 | 2.18E+01 |
| 2.60973 | 5.45351 | 0.02725 | 1.13674 | 7 | 2.28E+01 |
| 3.11584 | 6.46364 | 0.03259 | 1.19566 | 8.83 | 2.15E+01 |
| 3.61767 | 7.17085 | 0.03793 | 1.38898 | 11.03 | 1.84E+01 |
| 4.11522 | 7.68619 | 0.04338 | 1.44482 | | |
| 4.60742 | 8.38462 | 0.04796 | 1.44547 | | |
| 5.09427 | 9.08925 | 0.05341 | 1.46022 | | |
| 5.57791 | 9.50001 | 0.10791 | 1.77106 | | |
| 6.0562 | 9.9181 | 0.26585 | 2.6495 | | |
| 6.53021 | 10.49448 | 0.51905 | 4.0687 | | |
| 6.99994 | 11.0518 | 0.99081 | 6.64684 | | |
| 7.46432 | 11.39824 | 2.18 | 12.35116 | | |
| 7.92549 | 11.6384 | | | | |
| 8.38238 | 12.09288 | | | | |
| 8.83392 | 12.77916 | | | | |
| 9.28225 | 13.58009 | | | | |
| 9.63963 | 13.50043 | | | | |
| 10.16714 | 13.44599 | | | | |
| 10.60263 | 13.55038 | | | | |
| 11.03491 | 13.57211 | | | | |

TABLE 3
(a) Sensitivity parameters for Ag⁺ detection by the Au₃Pz₃/CS phosphorescent
sensor at various CS concentrations, upon baseline correction of the raw
data - corresponding to the data summarized in Tables 3b-3d below and FIGS.
11-13 (FIGS. 11a-13a, S/N > 3 method; 11b-13b, 10% method).

| | | | | Detection | Detection |
|---|---|---|---|---|---|
| | | Range Studied | Increment | Range | Limit |
| Detection Type | Sample | (ppm) | (ppm) | (ppm) | (ppb) |
| S/N > 3 | 1.0% CS | 0 to 11 | 0.52 | 0 to 9.3 | 37 |
| 10% Signal | | | | | 40 |
| Change | | | | | |
| S/N > 3 | 0.1% CS | 0 to 2.2 | 0.005 | 0 to 2.2 | 6.4 |
| 10% Signal | | | 14 | | |
| Change | | | | | |
| S/N > 3 | 0.1% CS | 0 to 11 | 1.5 | 0 to 7 | 8.2 |
| 10% Signal | | | | | 72 |
| Change | | | | | |

(b) Summary of PL intensity raw data and manipulation thereof used for the sensitivity parameters calculations in Table 3a for the 1.0% CS/0-11 ppm data. The bottom cluster of rows (16-21) was chosen for inclusion in Table 3a, given it most-accurately represents the pertinent noise level (FIG. 11a).

| Row | X (nm) | Y (N) | Y (S) | Y (S − N) | N | N * 3 | | |
|---|---|---|---|---|---|---|---|---|
| 1 | 401 | 185456 | 177613 | −7843 | 16054 | 48162 | | |
| 2 | 402 | 183350 | 180212 | −3138 | | | | |
| 3 | 403 | 179491 | 181023 | 1532 | | | 6.827038 | S/(N * 3) |
| 4 | 404 | 176824 | 185035 | 8211 | | | 0.52 | ppm (conc. @ S) |
| 5 | 470 | 92086.2 | 420890 | 328803.8 | S (0.52 ppm) | | 0.07617 | Detection limit (ppm) |
| 6 | | | | | | | 76.1677 | Detection limit (ppb) |
| 7 | | | | | | | | |
| 8 | 383 | 165260 | 160784 | −4476 | 16631 | 49893 | | |
| 9 | 384 | 167117 | 169281 | 2164 | | | | |
| 10 | 385 | 167453 | 175125 | 7672 | | | | |
| 11 | 386 | 164815 | 176970 | 12155 | S (0.52 ppm) | | 6.590179 | S/(N * 3) |
| 12 | 470 | 92086.2 | 420890 | 328803.8 | | | 0.52 | ppm (conc. @ S) |
| 13 | | | | | | | 0.07891 | Detection limit (ppm) |
| 14 | | | | | | | 78.9053 | Detection limit (ppb) |
| 15 | | | | | | | | |
| 16 | | | | | | | | |
| 17 | 366 | 50269.5 | 50971 | 701.5 | 7767.4 | 23302.2 | | |
| 18 | 367 | 54913.3 | 63382.2 | 8468.9 | S (0.52 ppm) | | 14.11042 | S/(N * 3) |
| 19 | 470 | 92086.2 | 420890 | 328803.8 | | | 0.52 | ppm (conc. @ S) |
| 20 | | | | | | | 0.03685 | Detection limit (ppm) |
| 21 | | | | | | | 36.8522 | Detection limit (ppb) |

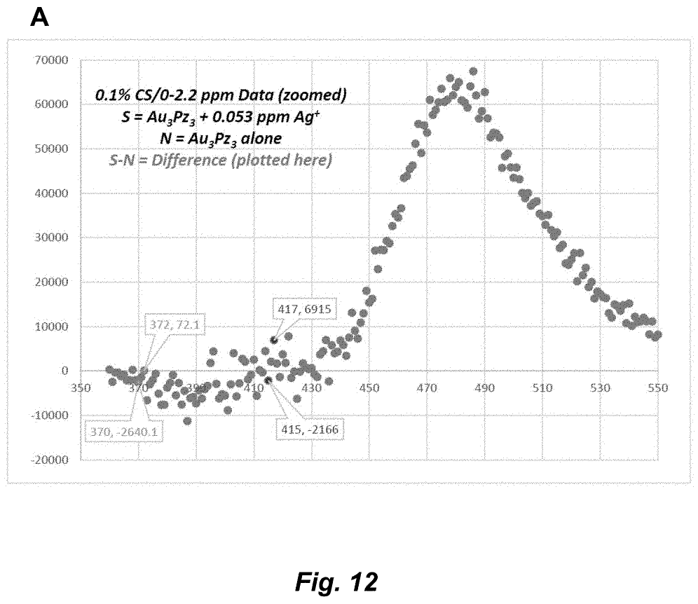

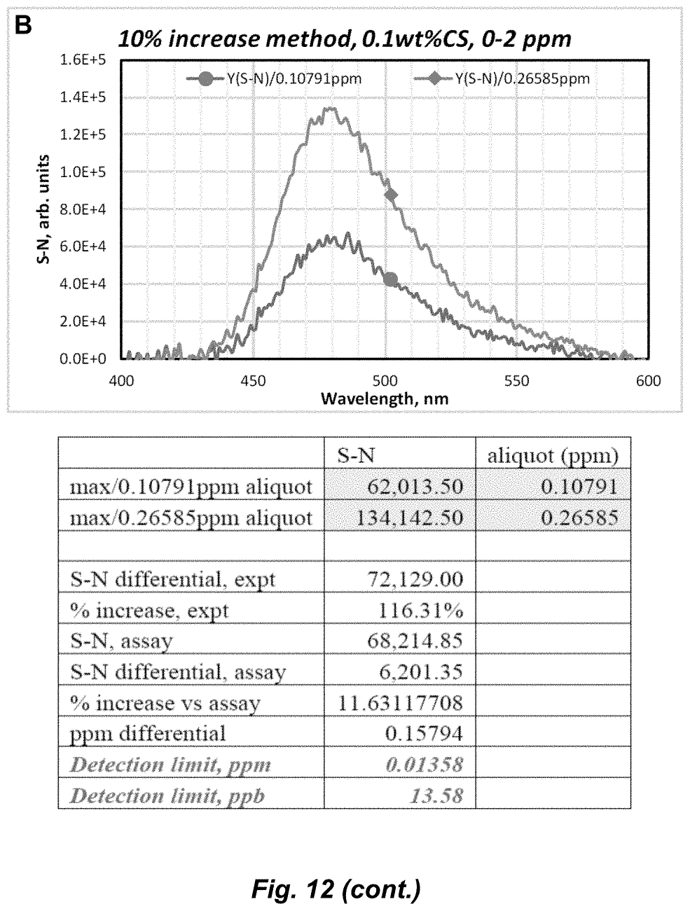

(c) Summary of PL intensity raw data and manipulation thereof used for the sensitivity parameters calculations in Table 3a for the 0.1% CS/0-2.2 ppm data. The italic rows with values were chosen for inclusion in Table 3a, given it most-accurately represents the pertinent noise level; see FIG. 12a.

| Row | N | N*3 |
|---|---|---|
| 1 | 2712.2 | 8136.6 |
| 2 | 9081 | 27243 |

| | |
|---|---|
| 3 | 486 nm (peak max) |

| | | |
|---|---|---|
| 4 | S-N | 67414.9 |
| 5 | S-N | 67414.9 |
| 6 | S/N*3 | 8.285389475 |
| 7 | S/N*3 | 2.474576956 |
| 8 | 0.05341 | ppm addition |
| 9 | 0.05341 | ppm addition |
| 10 | 0.00645 | Det. Limit (ppm) |
| 11 | 6.44629 | Det. Limit (ppb) |
| 12 | 0.021583 | Det. Limit (ppm) |
| 13 | 21.58349 | Det. Limit (ppb) |

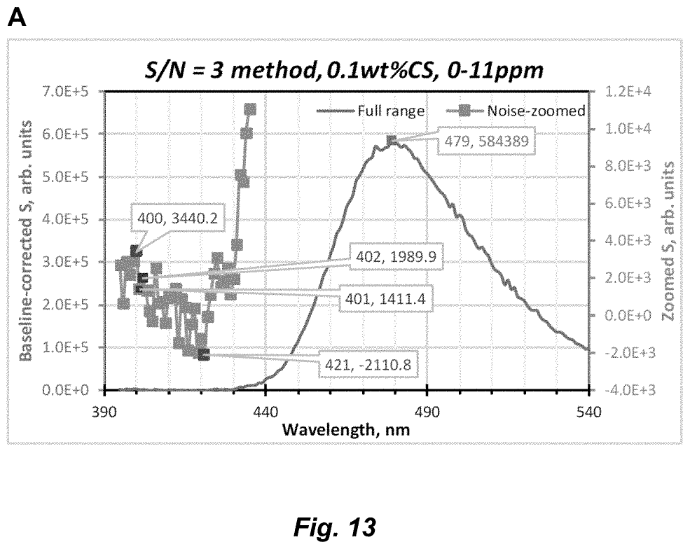

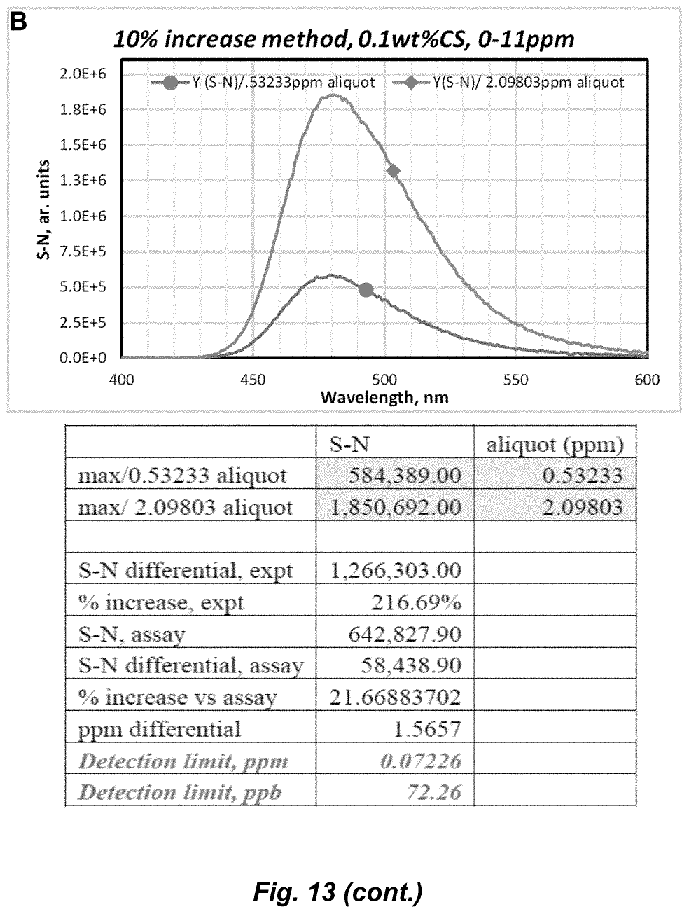

(d) Summary of PL intensity raw data and manipulation thereof used for the sensitivity parameters calculations in Table 3a for the 0.1% CS/0-11 ppm data. The italic rows with values were chosen for inclusion in Table 3a, given it most-accurately represents the pertinent noise level; see FIG. 13a.

| Row | | | |
|---|---|---|---|
| | High Noise | | |
| 1 | | N | 3N |
| 2 | | 5551 | 16653 |
| 3 | 479 nm | | S (max) |
| | (peak max) | | |
| 4 | 140261 | 724650 | 584389 |
| 5 | | S/(N*3) | ppm (S) |
| 6 | | 35.09211553 | 0.52 |
| 7 | | 0.014818143 | ppm |
| 8 | | 14.81814339 | ppb |
| 9 | Low Noise | | |
| 10 | | N | 3N |
| 11 | | 578.5 | 1735.5 |
| 12 | | S/(N*3) | ppm (S) |
| 13 | | 336.7265918 | 0.52 |
| 14 | | 0.00154428 | ppm |
| 15 | | 1.544279581 | ppb |
| 16 | Reported value (average hi & low noise) | | |
| 17 | | 0.008181211 | ppm |
| 18 | | 8.181211488 | ppb |

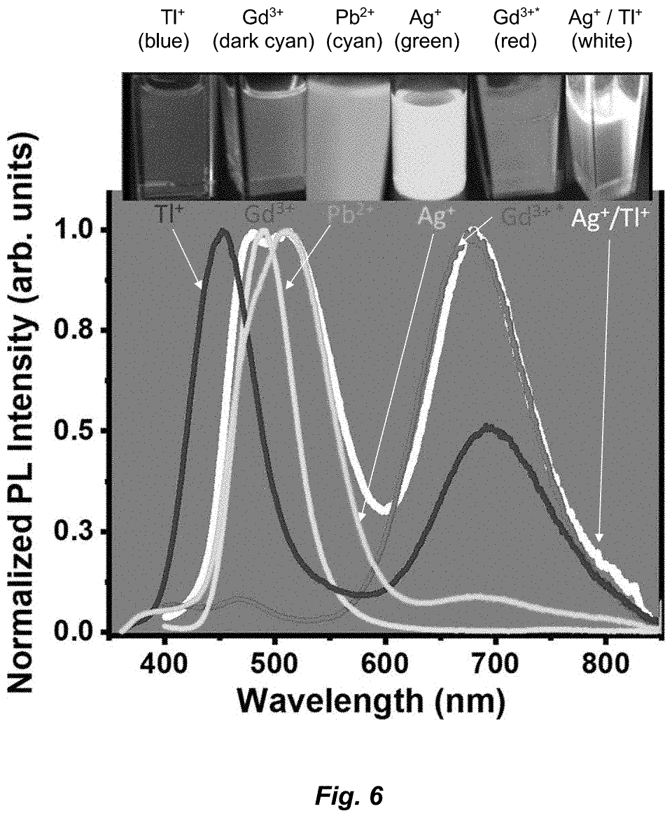

Sensing of other heavy-metal ions with Au₃Pz₃. It is evident from FIG. 3 and FIG. 4 that, at low concentrations (≤5 μM), Au₃Pz₃ is only sensitive to silver ions among the 15 salts tested. Nevertheless, at much higher concentrations, Au₃Pz₃ exhibits sensitivity to thallium at 85 mM TlNO₃ by developing a new blue emission (PL maximum at 450 nm with 315 nm excitation) as shown in FIG. 6. The lifetime of the Au₃Pz₃/Tl⁺ adduct was τ=0.907±0.06 μs, significantly reduced vs Au₃Pz₃ alone. Further, the PL of the thallium adduct is blueshifted compared to the silver adduct. Au₃Pz₃ also shows a similar response for lead ions at concentrations higher than 100 mM by developing a new emission peak at 490 nm with excitation at 338 nm (FIG. 6). This cyan PL color for the Au₃Pz₃/Pb²⁺ adduct is, therefore, qualitatively different from that for Au₃Pz₃/Ag⁺ or Au₃Pz₃/Tl⁺ adducts.

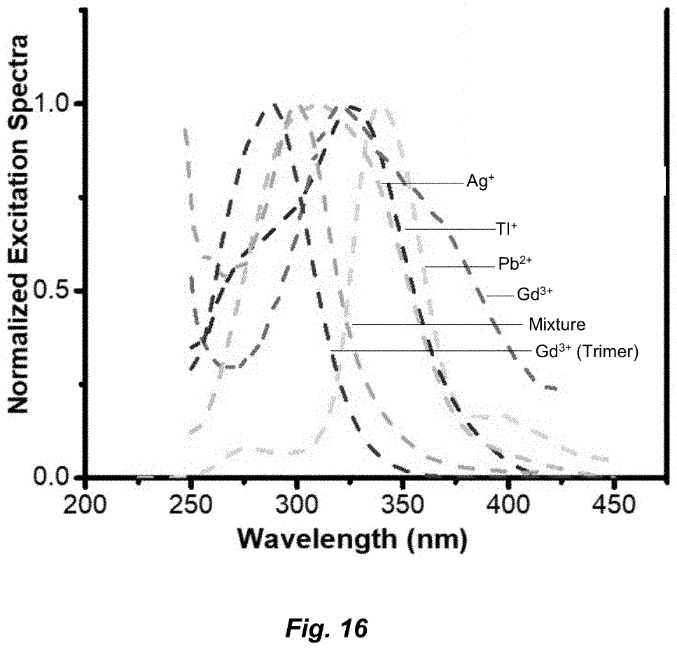

The PL spectral profiles show that there is no interference or overlap of emission maxima between the different heavy-metal ion adducts (FIG. 6 and FIG. 16). Although there is uncertainty about the exact mechanism of sensing with different metals, it is assumed the differences in supramolecular interactions between different metals result in different emission colors. The results presented in this paper indicate the origin of sensitivity to Tl⁺ and Pb²⁺ only at relatively higher concentrations compared to Ag⁺. On the basis of measurement range results of silver, however, it is believed that fine-tuning the wt % of CS polymer can aid in improving the sensitivity to Tl⁺ and Pb²⁺, as can be developed for Au₃Pz₃ and related trimers.

The other metal investigated was trivalent gadolinium, which has been primarily explored for bioimaging applications. FIG. 6 shows the PL spectrum of the Au₃Pz₃/Gd³⁺ adduct. Upon addition of Gd³⁺ ions (0.7 mM), a new weaker emission peak appeared at 468-470 nm under λ_{exc}˜320-400 nm, along with an enhancement in the red emission under λ_{exc}<300 nm, the latter result being unusual as all other ions have exhibited quenching in the red emission of Au₃Pz₃. The lifetime of the Au₃Pz₃/Gd³⁺ complex at 320/470 nm shows a single-exponential long lifetime τ=16.61±0.25 μs, indicating the newly evolved peak in the presence of Gd³⁺ is due to the formation of an Au₃Pz₃/Gd³⁺ adduct.

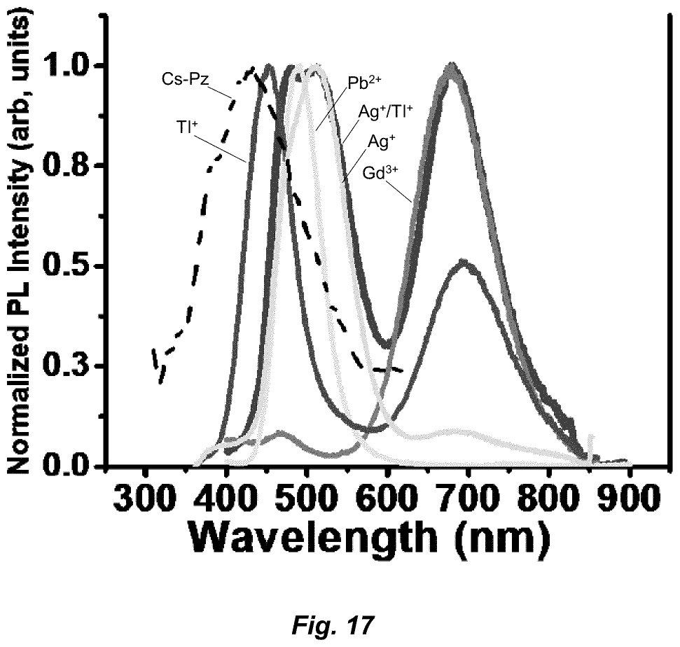

It was also found that, upon mixing the red emissive Au₃Pz₃, green emissive silver adduct, and blue emissive thallium adduct, a nearly white emissive mixture (FIG. 6) is obtained that exhibits a broad emission ranging from blue to red. This could be significant for solid-state lighting and/or video display applications associated with color mixing, including white. However, the spectra are not additive, as the Au₃Pz₃/Tl⁺ adduct emission appears red-shifted in the presence of Ag⁺; further optimization can attain suitable color metrics for such applications. In general, the sensitivity and selectivity of the Au₃Pz₃ sensor seem to favor the softer cations, consistent with the data in FIG. 6. In FIG. 17, the normalized emission spectra illustrate noninterference from the chitosan-pyrazole control, as does FIG. 11 for the baseline correction even at minute aliquot addition of Ag ions.

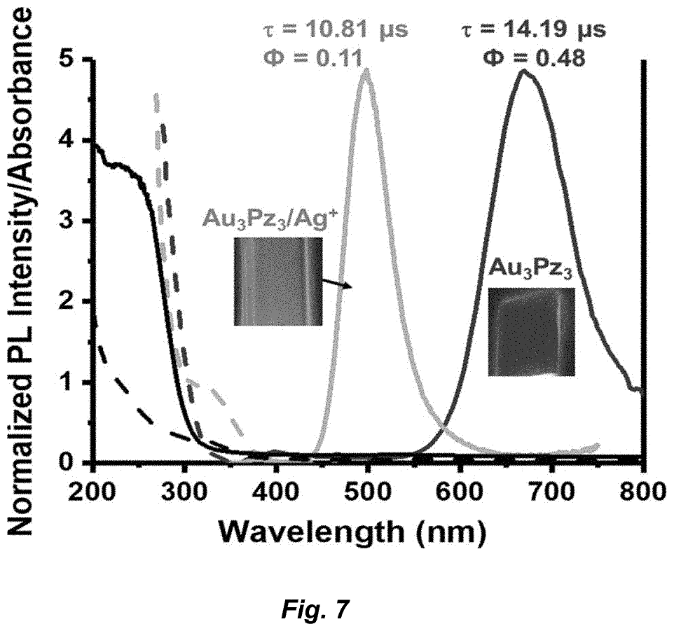

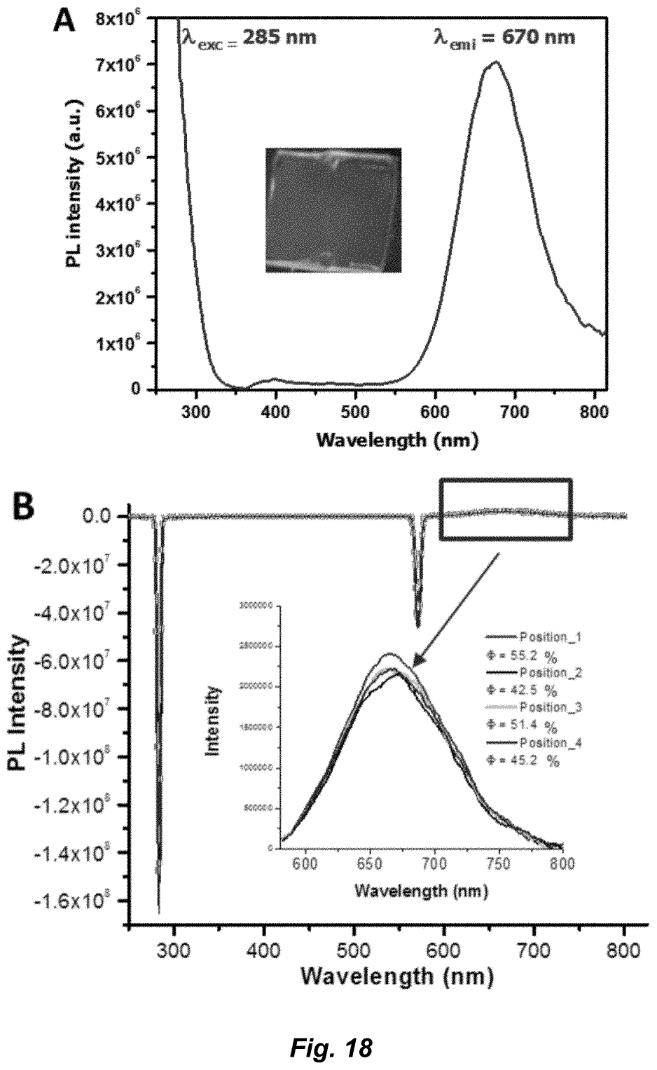

The film-forming ability of CS to investigate potential chemosensor films, as such films are more conducive to subsequent investigations to develop practical sensors (e.g., fiber-optic sensors and sensor stripes) has been exploited. Accordingly, thin films were fabricated from Au₃Pz₃ and Au₃Pz₃/Ag⁺ solutions by a simple drop-cast method. FIG. 7 and Table 1 provide details of the photophysical properties of the red-emissive and green-emissive thin films in comparison with the same systems in solution. FIG. 7 shows that the Au₃Pz₃ film possesses a much higher quantum yield (see FIG. 18 for PL and QY data) compared to the Au₃Pz₃/Ag⁺ silver adduct film, opposite to the solution behavior. In the case of films, Au₃Pz₃ has shown a drastic increase in quantum yield due to common solid-state behavior of Au(I) complexes, which exhibit better orientation and higher degree of intermolecular aurophilic aggregation required for their luminescence vs the solution phase. The silver adduct, on the other hand, exhibits a slight decrease in lifetime and quantum yield in the solid film vs solution. Stronger metal-metal bonding exists in the sandwich adduct vs the aurophilic dimer (e.g., d_{Ag—Au}˜2.9 Å in such adducts vs>3.3 Å for intertrimer d_{Au—Au} in uncomplexed trimers). This is expected to lead to greater survival chances for the Au₃Pz₃/Ag⁺ adduct in solution, whereas its further solid-state aggregation could attain self-quenching.

Conclusions: Reported herein is a chemo-optical sensor based on a novel phosphorescent Au(I) cyclotrimer complex (Au₃Pz₃=[Au(3-CH₃,5-COOH)Pz]₃) that is extremely selective and sensitive to silver ions in aqueous media. The Au₃Pz₃ is unconventionally synthesized in chitosan (CS) aqueous media and its photophysical and sensing properties are analyzed in detail. The chemo-optical sensor exhibits sub-ppm/nM range sensitivity for silver ions, whereas thallium and lead ions were also detected at micromolar concentrations. The presence vs absence of silver ions in aqueous polymer media was differentiated from starkly distinct differences in emission wavelengths, lifetimes and quantum yields of Au₃Pz₃ vs the Au₃Pz₃/Ag⁺ adduct. Selectivity, sensitivity, measurement range, and detection limit data all demonstrate room for optimization and for improvement in sensitivity for silver and other heavy metal ions using the same chemosensor and congeners thereof. This is believed to be the first documented silver sensing methodology by an Au(I) phosphorescent complex in the presence of (e.g., 15) other metal salts. Based on these results, it is believed that this heavy metal chemosensor possesses a great potential for practical applications such as detection of silver ions in drinking water or surface water (rivers, lakes reservoirs, etc.) and also in solution-processed functional light-emitting devices.

### Ratiometric Phosphorescent Silver Sensor: Detection and Quantification of Free Silver Ions Within Silver Nanoparticles

One of the largest sources of silver contamination is from engineered silver nanoparticles (AgNPs). Especially in the last decade, AgNPs have become very common in many commercially available products such as bedding, toothpaste, bandages, fabrics, deodorants, kitchen utensils, and toys—due to their known antibacterial properties. In addition, scientists further take advantage of the antibacterial properties of AgNPs by using them in other applications such as pharmacology, human and veterinary medicine, food industry, and water purification. The interest in using AgNPs as an antibacterial agent comes from the fact that certain bacteria such as MRSA are becoming resistant to antibiotics. The potential for silver as an alternative to antibiotics is due to the many studies showing silver's effectiveness on a wide range of bacteria. The potential mechanism of silver's antibacterial properties involves their accumulation in bacterial cells, resulting in shrinkage of the cytoplasm membrane and detachment from the cell wall. Therefore, DNA molecules become condensed and lose their ability to replicate.

Unfortunately, it is a known issue that silver ions are toxic to humans because silver can be absorbed through the lungs, gastrointestinal tract, mucous membranes, and skin. Studies have shown that there has not been any documented beneficial/essential physiological or biochemical role for silver in the human body. Excessive silver ion intake can lead to the long-term accumulation of insoluble precipitates in the skin, eyes, and other organs—causing various medical conditions. Therefore, the release of various silver species (silver nanoparticles and different silver salts) into the environment from multiple sources and applications is concerning. Understanding the toxic effects of free silver salts is arguably straight-forward and easily studied. However, studying the toxicity mechanism of AgNPs to various biological systems is not quite clear. This challenge is due to the dynamic transformation of AgNPs to silver ions upon interacting with the media. The chemical and morphological changes of AgNPs makes it difficult to understand the exact mechanism of toxicity of AgNPs in different media. Therefore, one important step would be the ability to differentiate the free silver ions leaching or the silver ions chemically transformed from AgNPs so that the toxicity specifically due to free silver ions vs AgNPs can be clearly understood.

Due to the fact that different NPs under different conditions (such as pH, size, and chemical composition) could greatly alter the physiochemical and morphological properties and thereby the toxicity of the AgNPs, it is important to characterize silver leaching in the specific environment of that particular application. The challenge of understanding the role of different species in different media can be made very easy if each of these species could be isolated and quantified. Currently, a combination of field flow fractionation (FFF) and inductively coupled plasma mass spectrometry (ICP-MS) are adapted in a combination with various other detectors to determine size and quantification of AgNPs in aqueous matrices.

Other combinations of detectors include simple UV-Vis spectrophotometer, centrifugal ultrafiltration and diffusive gradients for detection and separation of AgNPs based on their surface plasmon resonance and size. Additionally, there are numerous well-known approaches to quantify the silver ion concentration down to the part-per-billion (ppb) level. These techniques include atomic absorption (AA) spectroscopy, ICP-MS, and potentiometric methods based on ion-selective electrodes. Most of these methods are time-consuming, expensive and unable to differentiate AgNP from silver ions. Also, the sample preparation needed for these methods can induce changes to the properties of the AgNPs, which introduces uncertainty in the subsequent analytical results. These AgNPs modifications can create a large gap for understanding the actual interactions of different silver species in the environment and in biological systems. However, luminescent indicators are advantageous due to their high sensitivity, rapid response, and ease of use.

Nonetheless, there is still a challenge in quantifying the exact concentration of silver ions to the ppb level—even in the presence of silver nanoparticles—without sacrificing the AgNPs sample. This disclosure documents the development of an optical sensor sensitive to silver ion concentration in aqueous chitosan (CS) matrix down to the ppb range, and that uniquely identifies silver and differentiates free silver ions from AgNPs. Further, the ability of the sensor for sensing silver ions is not crippled in an AgNP medium. This differentiation between the AgNPs and silver ions is the first step towards determining the exact role of different silver species in terms of their relative contribution to the toxicity of AgNPs. Additionally, as discussed above, the same system has already demonstrated that the sensitivity of the sensor is not affected by the presence of other inorganic salts in the aqueous medium. In addition, this sensor can detect the leaching of silver ions from AgNPs over time, as well as being able to remediate these ions from solution.

### Results and Discussion

AuT selectivity for Ag⁺ ions: The synthesis, characterization and photoluminescence properties of the cyclic pyrazolate trimer have been extensively delineated, as discussed above. The changes in emission color of the Au(I)-pyrazolate trimer (AuT) from red (690 nm) to green (475 nm) in the presence of silver ions has been demonstrated using the same complex, as discussed above. The factors affecting the green emission at 475 nm in the presence of silver and its detection limits in different polymer concentrations were also clearly documented. Additionally, this disclosure shows that the selectivity and sensitivity of the trimer for silver ions is not affected by the presence of numerous other inorganic salts. Realizing the significance of differentiating the presence of silver ions vs AgNPs, the first step was to ensure that the sensor only responds to free silver ions (monovalent Ag⁻ form) and not the AgNPs (zero-valent Ag(0) form) in solution.

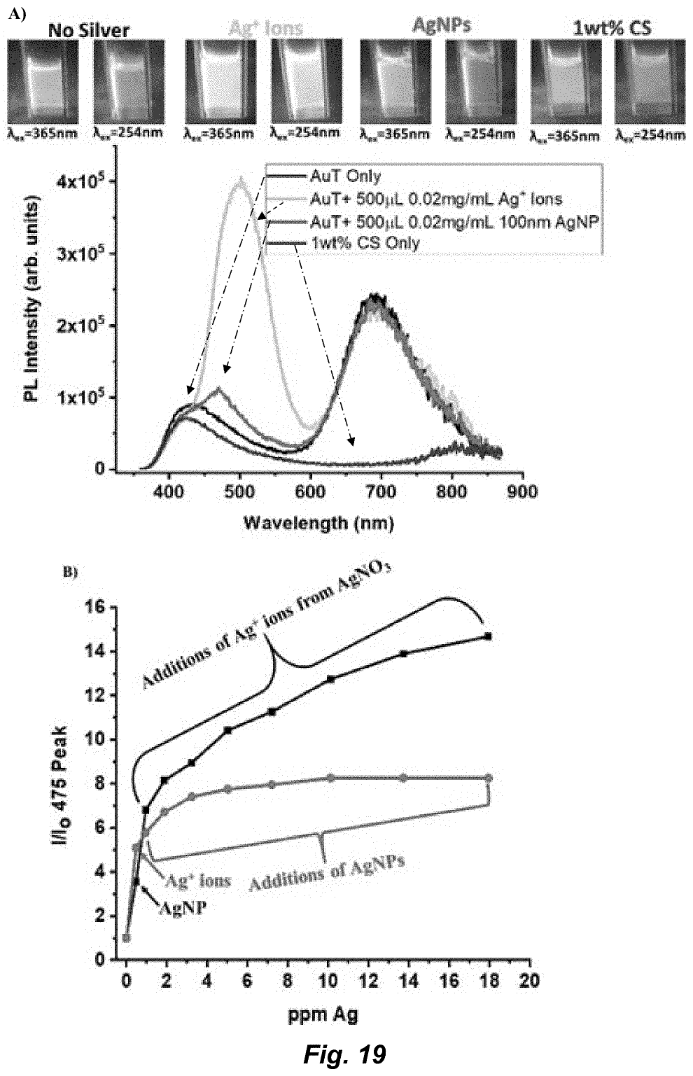

The photoluminescence (PL) spectra and emission color changes of the samples in FIG. 19A demonstrate the capability of the sensor to selectively detect free silver ions and differentiate those silver ions from AgNPs. The figure shows that upon addition of 0.01 mg of 100 nM AgNPs to AuT, a very minor change in the PL spectrum of the AuT complex is observed. The rise of a weak emission shoulder at 475 nm is due to the interaction of AuT with small amounts of free silver ions in the AgNPs solution. Comparatively, the results show that upon addition of the same concentration of Ag⁺ ions (0.01 mg), a distinct green emissive peak is formed which is 4× more intense than the AgNPs emission response. The inset pictures clearly show that the samples containing silver ions vs AgNPs are easily differentiated when excited with a hand-held UV lamp. This represents strong evidence that the AuT sensor exhibits formation of a green-emitting sandwich adduct described in ref 15. This allows for easy differentiation and quantification of free silver ions from AgNPs in solution without additional sample preparation. As discussed above, this disclosure establishes that the peak maxima of Ag⁺—AuT sandwich adduct's green emission exhibit a minor shift from 475 nm to 500 nm at higher concentrations of free silver (Anal. Chem. 2018, 90, 4999).

Upon close comparison of the silver adduct peak maximum in both the AuT+AgNPs and AuT+Ag⁺ solutions (FIG. 19A), a noticeable shift from 475 nm to 500 nm is observed. The 475 nm peak maximum corresponding to the silver adduct peak in the AgNP solution indicates the presence of an insignificant amount of free silver ions in the AgNP solution. This is expected based upon the stability and continuous chemical transformations of AgNPs in solution. However, in the presence of free silver ions of the same concentration, the silver adduct exhibits an emission peak maximum at 500 nm with a much higher PL intensity, indicating a much higher concentration of free silver ions. This result is very significant because it suggests AuT's selectivity to free silver ions vs AgNPs. Additionally, it suggests the ability of the sensor to detect very low concentrations of silver ions in an NP medium—undisturbed by the presence of AgNPs. The blue color noticed in the inset picture (FIG. 19) is the background interference arising from the 1 wt % CS polymer that mediates the in-situ synthesis of AuT. The inset pictures and the spectra clearly show that the CS polymer does not affect the silver sensing of the AuT system.

In order to more precisely understand the interference of AgNPs on sensing free silver ions, two different titration experiments were conducted, as shown in FIG. 19B. The square dotted line in FIG. 19B represents data for the addition of free silver ions to an existing aliquot of AuT/AgNPs solution, while the round dotted line represents the addition of AgNPs to an existing solution of AuT/Ag⁺. The x-axis clearly shows that in both cases, the same amount of silver (free silver or AgNPs) was added to the AuT complex. The continuous increase in the intensity of the 475-nm peak for the free silver titration graph (square dotted line), clearly indicates the continuous complexing of AuT with free silver ions even in the presence of AgNPs. On the other hand, except for the first Ag⁻ addition, the 475 nm PL signal remains constant during the AgNP titration experiment. This result clearly indicates the sensor's selectivity for free silver ions even in the presence of AgNPs. If this sensor were equally sensitive to both Ag⁻ ions and AgNPs then both the square and round dotted lines would overlap with each other. The weak response of the sensor to the AgNPs addition (round dotted line) could be due to the presence of free silver ions in AgNPs solution, as noticed in FIG. 19A.

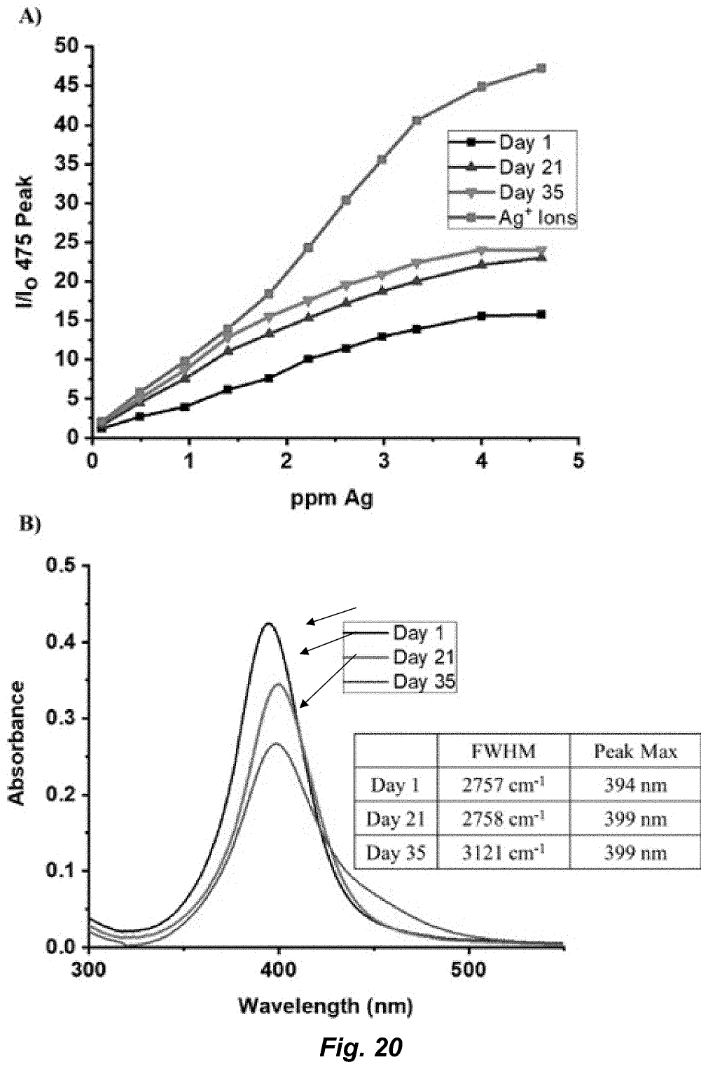

Sensing Ag^{|} ion leaching from AgNPs: Now that it has been established that this sensor only detects free Ag⁺ ions in solution, the ability of the sensor to determine the leakage/leaching of silver from AgNPs in solution over time was evaluated. The chemical transformation of AgNPs into various silver species is one of the most challenging aspects for clearly understanding the toxicity of AgNPs in the environment. Information regarding the release or leakage of silver ions from AgNPs would be extremely helpful in this respect. FIG. 20A illustrates the AuT sensing of silver leaching/leakage from AgNPs over time. The same concentration of 20 nM AgNPs was titrated into the sensor on day-1, day-21, and day-35. Between experiments, the AgNPs were stored at room temperature and under ambient light to promote leaching/leakage of silver ions.

Based on FIG. 20A, the increase in I/I₀, indicates the leakage of silver ions from AgNPs over time. In addition, changes in the AgNP properties (surface plasmon resonance (SPR), stability, and aggregation) were monitored using UV-Vis data as collected throughout the experimental time period. FIG. 20B shows the changes in the SPR of the 20 nM AgNPs sample on day-1, day-21, and day-35, respectively. FIG. 20B clearly shows a decrease in absorbance of the AgNPs that would result either from a partial transformation of AgNPs to silver ions or from the aggregation of the AgNPs. The increase in the full-width-at-half maximum (FWHM) of the SPR peak from 2757 cm⁻¹ to 3122 cm⁻¹ over the course of the experiment clearly indicates that AgNPs were aggregating. In addition, the shift in peak max from 394 to 399 nm is another indication of aggregation. This is to be expected since the AgNP samples were not stored properly in order to maximize their stability, given the necessity to accelerate their aggregation or decomposition for this study. However, from FIG. 20A the increase in silver ion concentration due to the transformation of AgNPs is clearly indicated by the increase in I/Iₒ.

Based on these data, it can be concluded that the AgNP samples were aggregating as well as leaching silver ions. Further studies are warranted to determine how this aggregation affects silver ion leaching. An advantage of this sensor is the ability to use simple UV-Vis data to understand the physical and chemical changes of the AgNPs. In the absence of such a straight-forward and cost-effective optical sensor, the analysis of silver leakage would require the use of ICP-MS or AA instrumentation with rigorous sample preparation that compromises the sample quality in terms of representing the identity of its silver species constituents. These data clearly indicate the ability of the sensor to detect the leakage of silver ions from AgNPs. Also, in combination with simple UV-Vis spectroscopy, the sensor can help one understand the aging and decomposition of AgNPs, which involves the aggregation of AgNPs and/or release of free silver ions.

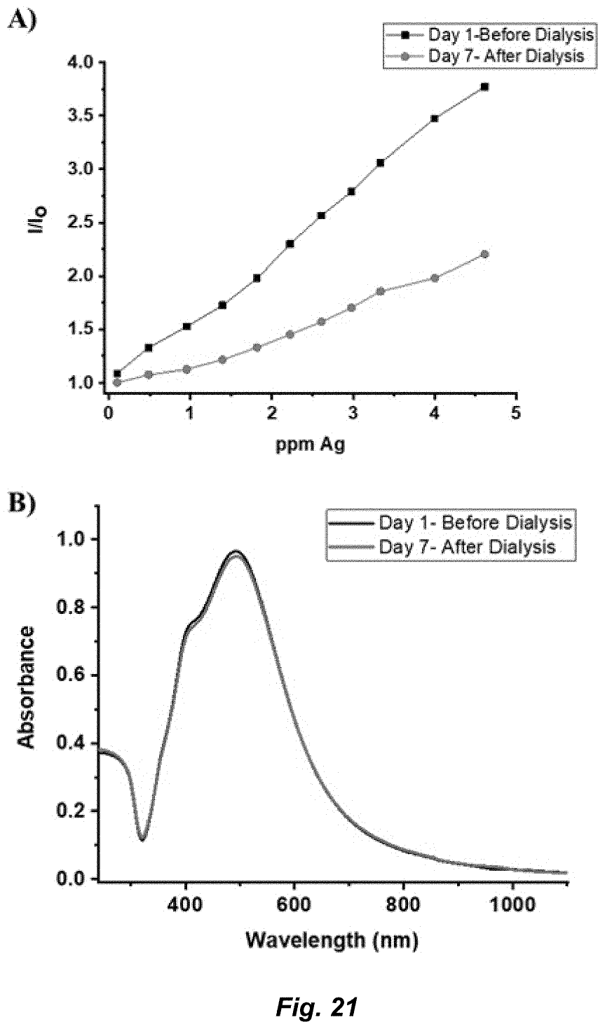

Next investigated was the sensor's ability to detect and differentiate the presence/absence of free silver ions after dialyzing the AgNPs (FIG. 21). After sensing the initial silver content in the AgNPs (square dotted line in FIG. 21A), the AgNPs were then placed in dialysis tubing (3000 Da) and dialyzed for 7 days. After this dialysis, the silver content of the AgNP solution was retested and showed a drastic decrease in the sensor's response—indicating the presence of very minute quantities of free silver ions that were not removed during dialysis (FIG. 21A). It is believed that there is a dynamic equilibrium between AgNPs and free silver ions; therefore, further removal of silver ions was not possible even by dialysis.

Along with the PL data, UV-Vis spectra were also acquired for the AgNPs before and after dialysis. Initially, the UV-Vis data could seem to apparently contradict the PL data; however, this is not the case. Specifically, according to the UV-Vis data, there was no change in the AgNP concentration, size or stability before and after dialysis. However, these PL data show rather clearly that the sensor has the potential to identify very small concentrations of free silver ions that are associated with the AgNPs. These data show the advantage of the disclosed silver sensor over conventional AgNP characterization techniques such as UV-Vis. Specifically, AgNPs have very high extinction coefficients; consequently, sensing small changes in AgNP concentration is very difficult. In addition, the dialysis water was also tested for the presence of silver ions.

No silver ions were sensed within the dialysis water itself due to the extremely small concentration of silver ions removed from AgNPs. Therefore, sensing such a small concentration of silver ions would prove challenging even to extremely sensitive techniques such as AA. These data illustrate the advantage of the disclosed sensor in that it is able to detect small changes in silver concentration within an AgNP medium where common techniques like UV-Vis and AA are unable to detect such small changes.

AuT Ag⁺ remediation from solution: Based on literature data on other cyclic systems, the disclosed Au(I) systems have a strong affinity to form “sandwich” adducts with heavy metals within cyclic trimer rings. It is well established that these complexes are luminescent due to the formation of cyclic dimer-of-trimer units. The luminescence of this complex changes from red to green upon formation of a “sandwich” complex with free Ag⁺ ions. Taking advantage of this chemistry, studies were performed to determine if this sensor could not only sense silver ions in solution but whether it could also have the potential to remediate/extract those ions from that solution. Such a sensor could be utilized for both sensing and remediation applications. Silver ions have been shown to be toxic for various biological systems. Therefore, it would be highly advantageous to not only sense their presence but also remediate them from the environment.

Additionally, the simple and straightforward synthesis of this sensor would be advantageous for its large-scale usage. To begin, the sensitivity of silver ions at pH 4 and 6 were compared in order to understand if the ligand played a critical role for interacting with silver ions, or if the silver is exclusively forming a sandwich adduct with the AuT. This study was done in the absence of the CS polymer to minimize any background interference from the polymer and also to obtain a clear picture of the interactions of the trimer with the silver ions.

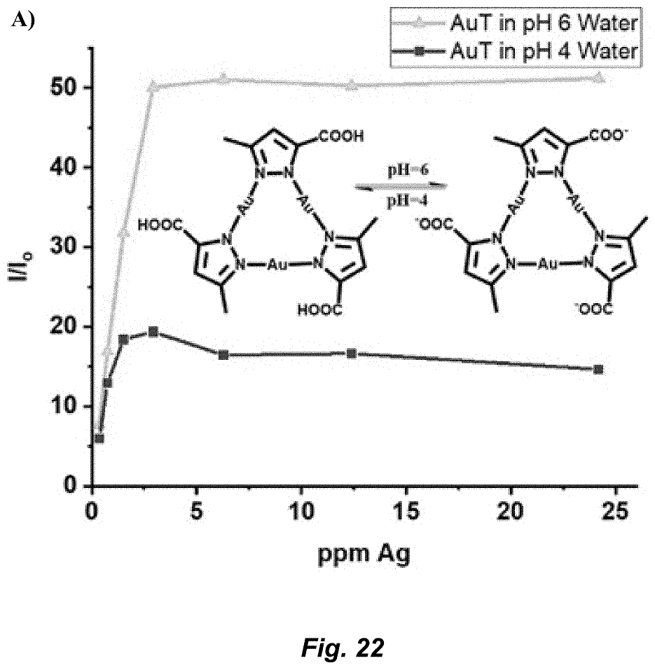

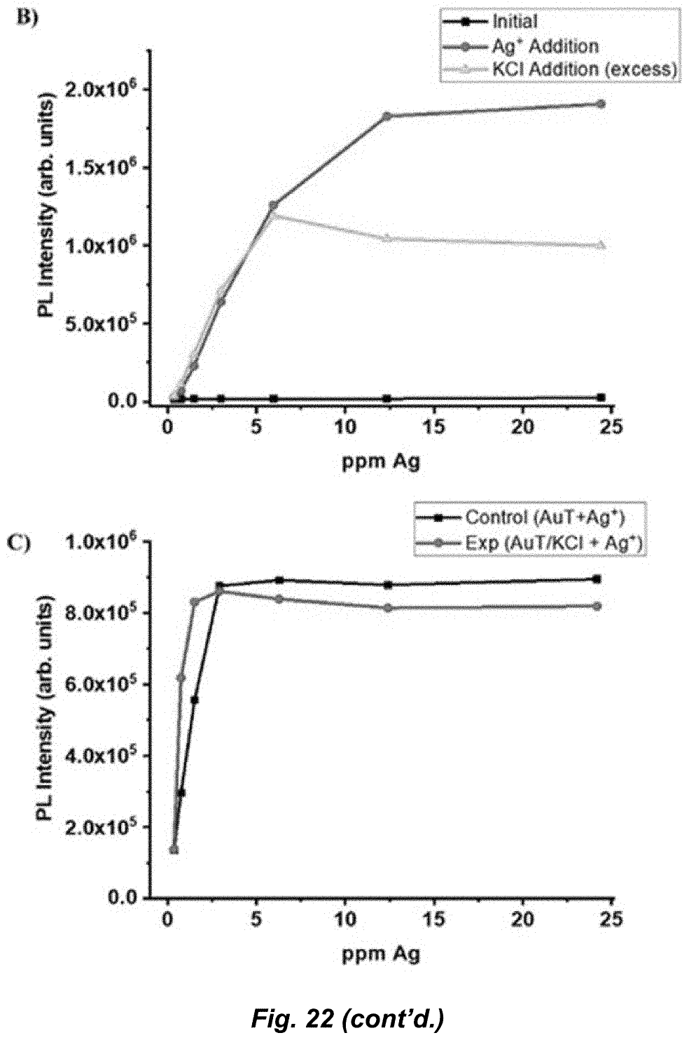

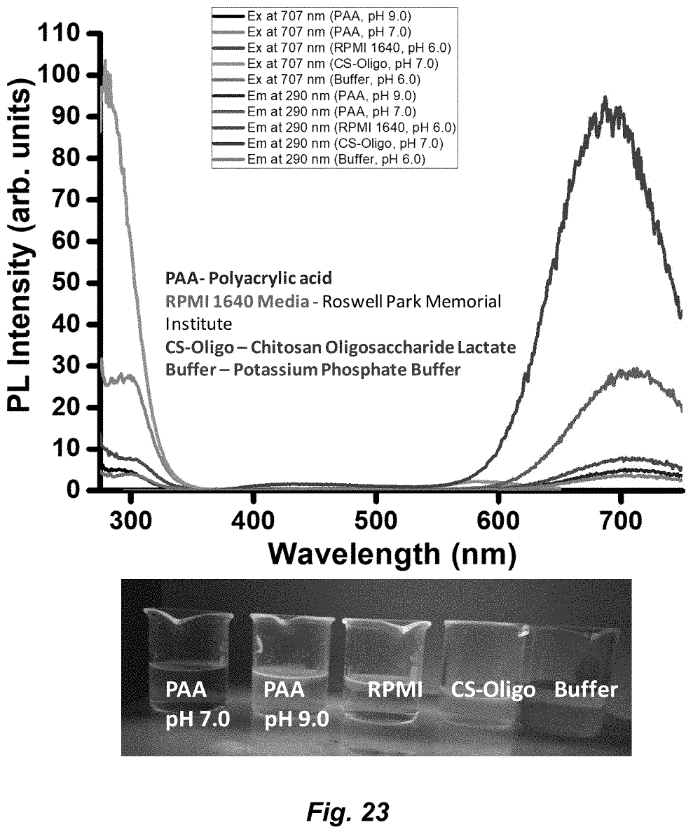

From the data in FIG. 22A, a clear relation between the pH and sensitivity is noticed. There was a huge increase in sensitivity of the complex by 2.5 times at pH 6 compared to pH 4. Based on these data, one can conclude that the change in sensitivity is due to deprotonation of the carboxylic acid at pH 6. Therefore, the enhanced sensitivity clearly demonstrates that—along with the formation of a sandwich structure—the interaction of free Ag⁺ ions with the anionic ligand are playing a vital role during the sensing process. Due to this, the rest of the data collected in FIGS. 22B and 22C were done at pH 6. FIG. 22B shows the addition of silver salt followed by addition of KCl salt. Each point on the graph represents a new aliquot of the same stock solution of AuT. The KCl was added after the addition of silver ions to determine if silver precipitation by chloride would affect the PL intensity of the green emission. As seen from the data, KCl addition had no effect on the PL intensity up to about 5 ppm.

At higher concentrations of silver ions, the presence of KCl does result in a significant decrease in the PL intensity of the green emission due to the formation of AgCl. It is postulated that this decrease in PL intensity occurs after 5 ppm because, initially, the sandwich complex is forming, therefore the “sandwiched” silver ions within the cyclic trimer units are unavailable to react with the KCl. However, at higher concentrations of silver ions, the excess silver ions are hypothesized to interact with the carboxylated pyrazolate ligand, based on FIG. 22A data, and are freely available to interact with the excess of KCl—resulting in the quenching of the green PL of the adduct. This data set clearly complements the pH-dependent sensitivity of the sensor. FIG. 22C shows data from a similar experiment except for the addition of KCl to the trimer before addition of silver salt to determine how KCl would change the sensitivity of the AuT when initially present in the medium. FIG. 22C shows clearly that even in the presence of KCl, the complex's ability to sense silver was not affected, as indicated from the control experiment (square dotted line in FIG. 22C). Comparing with the control data, it is evident that the presence of salts like KCl does not affect the complex's ability to sense free silver ions at low ppm levels. This is a very important result for the application of this sensor in water environments where the water medium is known to contain different salts. These data show that even in the presence of KCl, silver ions seem to preferentially interact with the AuT complex. Therefore, it can be concluded that—regardless of the order of addition of KCl to AuT—the sensor herein is still able to remediate silver ions from aqueous solution.

Conclusions: In conclusion, a sensor has been developed that is able to differentiate between Ag⁺ ions and AgNPs. One of the great utilities of the sensor is to help nanoparticle researchers to differentiate and understand if the toxicity of the AgNPs is due to AgNPs alone, leaching of silver ions, or due to a combination of both. Currently, differentiation of silver ions from AgNPs directly in solution is not possible using any single existing techniques. Differentiation of AgNPs from Ag⁺ ions is vital since AgNPs are used in many commercially available consumer products increasing the likelihood of human exposure. Not only was the disclosed sensor able to differentiate between Ag⁺ ions and AgNPs, but it was also able to sense the leakage of Ag⁺ ions from the AgNPs as well as remediate those ions from solution. The remediation data not only showed the removal/extraction of toxic silver ions from the medium but also demonstrated the first step in making a reusable Ag⁺ sensor. Further investigations should involve the application of this sensor in biological systems to exactly understand the toxicity mechanism of AgNPs in vitro and in vivo.

The following Example is intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLE

### Example 1

### Experimental

Materials. The gold precursor, gold (tetrahydrothiophene)chloride (Au(THT)Cl), was synthesized by following literature procedures (Uson, R.; et al., J. P. Jr. 1986, Tetrahydrothiophene Gold (I) or Gold (III) Complexes, Inorganic Syntheses, 26 (ed Kaesz, H. D), John Wiley & Sons, Inc./Hoboken, N.J., USA. Ch17.). 3-methyl-1H-pyrazole-5-carboxylic acid (ligand), cadmium nitrate, gadolinium acetate hydrate, and europium perchlorate were purchased from Alfa-Aesar. CS low molecular weight (85% deacetylated) was purchased from Sigma-Aldrich as well as silver nitrate, thallium nitrate, mercury nitrate, iron perchlorate hydrate, aluminum chloride hydrate, manganese iodide, calcium hydroxide copper sulfate, cesium hydroxide, potassium nitrate, cobalt nitrate, lead nitrate and nickel chloride and zinc acetate. All chemicals were used as received without further purifications.

Silver nanospheres stabilized in polyvinylpyrrolidone (PVP) used in this study (0.02 mg/mL; 20-nm and 100-nm diameter) were purchased from nanocomposix. The gold precursor, Au(tetrahydrothiophene)Cl (Au(THT)Cl), was synthesized by following literature procedure of Uson, R., et al. referenced above. Silver nitrate, potassium chloride, low-molecular-weight chitosan (CS), and 5-methyl-1H-pyrazole-3-carboxylic acid were purchased from Sigma Aldrich and used without further purification.

Physical measurements. Steady state photoluminescence (PL) spectra were acquired with a PTI QuantaMaster Model QM-4 scanning spectrofluorometer attached with a 75-watt xenon arc lamp. The xenon flash lamp was used to acquire the lifetime data. The direct quantum yield was measured following a previously described method, using an integrating sphere. pH measurements were made using a Hanna instrument HI1053B pH probe. Electronic absorption spectra were obtained with a Perkin-Elmer Lambda 900 double-beam UV-Vis-NIR spectrophotometer. ¹H-NMR spectra were acquired in deuterated dimethyl sulfoxide (DMSO-d₆) on a 400 MHz Varian spectrometer with a relaxation time of 6 seconds. Electrospray ionization mass spectrometry (ESI-MS) data were acquired with a Thermo Finnigan LCQ DECA XP Plus, using atmospheric pressure chemical ionization (APCI) with a quadruple ion trap detector. Samples were then prepared in 50:50% water and methanol followed by addition of acetic acid to facilitate the ionization. Fourier-transform infrared (FTIR) data were acquired on a Thermo Scientific Nicolet 6700 FTIR spectrophotometer equipped with a diamond attenuated total reflection (ATR) attachment. Zeta potential measurements were performed on a zetasizer nano ZS (Malvern Instruments).

In situ synthesis of Au₃Pz₃ in aqueous CS media. Chart 1 (A) illustrates the formation of Au₃Pz₃ in aqueous CS media. Although the synthetic procedure relevant to the formation of Au₃Pz₃ in aqueous/aqueous polymer media has been developed as described herein, the use of a polymer matrices to immobilize/stabilize chemo-optical sensors is a well-known technique. An excess amount of the pyrazole was transferred into a reaction flask containing 1% wt/v CS polymer in deionized (DI) water and stirred for 10 minutes. The pH of the solution was adjusted with 1M NH₄OH to be close to the pKa of CS (˜6.5) at which all measurements were conducted herein; pH-dependent studies are ongoing. Then, a submolar quantity of solid Au(THT)Cl was added directly into the ligand-CS aqueous mixture and stirred for 2 more hours, resulting in a visually clear (colorless) yet red-emissive Au₃Pz₃ solution. To understand the role of the CS polymer, the same experimental procedure was adopted for the synthesis of Au₃Pz₃ in polymer-free DI water.

Synthesis of the gold trimer (AuT) sensor: A 10-mL sample of dialyzed 1 wt % CS was added to a beaker. Then, 15 mg of 3-methyl-1H-pyrazole-5-carboxylic acid was dissolved in 1 mL of methanol, added to the CS and allowed to stir for 10 min. After stirring, a 240-μL aliquot of 2 M NH₄OH was added to increase the pH to around 6.5. Lastly, a 5-mg sample of Au(THT)Cl was added and the solution was allowed to stir for 45 minutes. Any undissolved gold was centrifuged out, resulting in a clear solution.

Preparation of solutions. Stock solutions with the required concentrations of different heavy-metal salts were prepared using Milli-Q DI water (18.2 MOhm-cm). For photoluminescence titration studies, a known concentration of metal salt solution was added to a 2 mL aliquot of the Au₃Pz₃ solution. PL spectra were recorded before and after each addition.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A trinuclear Au(I) complex of Formula I: 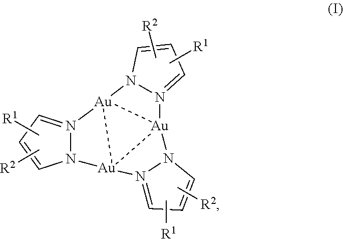
or an ion thereof; wherein:
R¹ is —CO₂H, or branched or unbranched —(C₁-C₆)alkyl-CO₂H; and
R² is H, halo, branched or unbranched —(C₁-C₆)alkyl, or aryl;
wherein —(C₁-C₆)alkyl and aryl are optionally substituted.

2. The complex of claim 1 wherein R¹ is —CO₂H and R² is branched or unbranched —(C₁-C₆)alkyl.

3. A chemosensor composition comprising:
a) a cyclic gold(I) trimer;
b) a nitrogen heterocycle having a carboxylic acid substituent; and
c) a polysaccharide in aqueous media at a pH of about the pKa of the polysaccharide;
wherein the gold(I) trimer and the heterocycle form a complex via N—Au—N coordinate covalent bonds, and the composition is phosphorescent, exhibits a red emission at about the pKa of the polysaccharide, and has a Stokes shift of at least about 150 nm.

4. The chemosensor of claim 3 wherein the heterocycle is a pyrazole or a pyridazine.

5. The chemosensor of claim 3 wherein the polysaccharide is a glycosaminoglycan or chitosan.

6. The chemosensor of claim 3 wherein the amount of the polysaccharide in aqueous media is about 0.05% wt/v to about 5% wt/v.

7. The chemosensor of claim 3 wherein the red emission is at a wavelength of about 650 nm to about 750 nm, the Stokes shift is about 200 nm to about 500 nm, or a combination thereof.

8. The chemosensor of claim 3 wherein the pH is about 6.0 to about 7.5.

9. The chemosensor of claim 3 wherein the chemosensor has a phosphorescence quantum yield of about 5% or greater and a phosphorescence lifetime of about 3 microseconds or greater.

10. The chemosensor of claim 3 wherein the complex comprises Formula I: 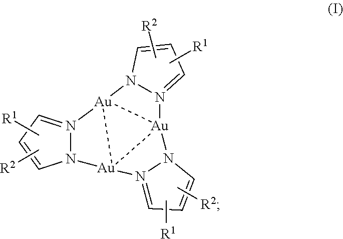
or an ion thereof, wherein:
R¹ is —CO₂H, or branched or unbranched —(C₁-C₆)alkyl-CO₂H; and
R² is H, halo, branched or unbranched —(C₁-C₆)alkyl, or aryl;
wherein —(C₁-C₆)alkyl and aryl are optionally substituted.

11. The chemosensor of claim 10 wherein the complex comprising Formula I is a complex comprising X: 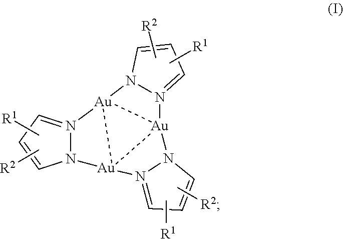
or an ion thereof.

12. The chemosensor of claim 10 wherein the complex is stabilized by the polysaccharide, wherein the polysaccharide comprises amine substituents, and the complex is stabilized via ion pairing of a carboxylic acid group R¹ of Formula I and an amino group of the polysaccharide.

13. The chemosensor of claim 12 wherein the stabilized complex has a surface charge that is reduced by about 5 mV to about 20 mV relative to a non-stabilized complex of Formula I.

14. The chemosensor of claim 12 wherein the composition is photostable wherein about 4 hours of UV irradiation of the composition results in less than 10% photobleaching.

15. A composition comprising the trinuclear Au(I) complex according to claim 1 and a metal ion wherein the metal ion is sandwiched by two complexes to form a sandwich complex.

16. A method of chemosensing metal ions comprising:
a) contacting a sample comprising metal ions with the chemosensor composition according to claim 3, wherein the chemosensor composition forms phosphorescent adducts with the metal ions; and
b) sensing the emission color of the phosphorescent adducts;
wherein the metal ions are sensed via a difference in the emission color of the chemosensor composition and the phosphorescent adducts.

17. The method of claim 16 wherein the emission peak of the phosphorescent adducts is blue shifted.

18. The method of claim 16 wherein the metal ions are silver, thallium, lead, or gadolinium.

19. The method of claim 16 wherein the emission intensity of the phosphorescent adducts is at least about 5 times greater than the emission intensity of the chemosensor composition of claim 3.

20. A method of sensing a presence or absence of silver ions in a sample comprising:
a) contacting a sample with the chemosensor composition according to claim 3 to form a mixture, wherein the chemosensor composition forms a phosphorescent adduct with a silver ion when the sample comprises silver ions; and
b) sensing the emission color of the mixture;
wherein a presence of silver ions in the sample is sensed via a difference in the emission color of the chemosensor composition and the mixture when the concentration of silver ions in the sample is above about 5 ppb; and
wherein an absence of silver ions in the sample is sensed via no essential difference in the emission color of the chemosensor composition and the mixture when the concentration of silver ions in the sample is below about 5 ppb.

21. The method of claim 20 wherein a green emissive adduct indicates a concentration of silver ions of at least 5 ppb.

22. The method of claim 20 wherein the sample comprises silver nanoparticles; and wherein the chemosensor composition is insensitive to zero-valent silver (Ag⁰).
